(19) United States
(12) Patent Application Publication
(10) Pub. No.: US 2026/0357581 A1
(43) Pub. Date: Nov. 12, 2026

(54) BUILDING PANEL

(71) Applicant: ARMSTRONG WORLD INDUSTRIES, INC., Lancaster, PA (US)

(72) Inventors: Ying Chang, Lancaster, PA (US); Carlos X. MEDINA, Lancaster, PA (US); Philip Weber, York, PA (US)

(21) Appl. No.: 19/136,059

(22) PCT Filed: Dec. 6, 2023
(86) PCT No.: PCT/US2023/082696

§ 371 Date: Jun. 5, 2025

Related U.S. Application Data
(60) Provisional application No. 63/431,393, filed on Dec. 9, 2022.

(51) Int. Cl. E04F 13/08; B32B 3/06; B32B 9/04; C04B 9/04

(52) U.S. Cl. CPC E04F 13/0894; B32B 3/06; B32B 9/04; C04B 9/04; E04F 13/0846; B32B 2307/72; B32B 2307/7376; B32B 2607/00

(57) ABSTRACT

Described herein is a building panel comprising a body having a core, wherein at least a portion of a volume of the core is occupied by a composite comprising MgO and MgSO₄, and a thickness of the core is greater than 85% of a thickness of the body.

### CROSS-REFERENCE TO RELATED APPLICATIONS

This application is a United States Non-Provisional Application claiming priority to PCT International Application No. PCT/US2023/082696 Filed on Dec. 6, 2023, which claims priority to U.S. Provisional Patent Application No. 63/431,393, filed on Dec. 9, 2022, the disclosures of which are incorporated herein by reference in their entirety.

### BACKGROUND

There are limitations of existing building surface covering products. For example, mineral fiber or fiberglass-based products may have relatively low impact resistance, while metal-based products can be costly and have low insulating capabilities. Wood or plastic-based products may not have sufficient fire rated performance. Additionally, wood-based products can be sensitive to moisture and water, which may affect their dimensional stability and durability and limit their use in outdoor/exterior applications.

Thus, a need exists to improve upon building panels that can be suitable for both interior and exterior applications and that are also aesthetically pleasing and easy to install.

### BRIEF SUMMARY

According to some embodiments, the present invention is directed to a building panel including a body having a core. The core may include a first major surface, a second major surface opposite the first major surface, a thickness defined by a distance between the first major surface and the second major surface, and a volume defined at least in part by the first major surface and the second major surface. At least 95% of the volume of the core may be occupied by a composite including MgO and MgSO₄. The thickness of the core may be greater than 85% of a thickness of the body.

According to some embodiments, a building panel may include a body. The body may include a core having a first major surface and a second major surface opposite the first major surface, a first facing over at least a portion of the first major surface of the core, and a second facing over at least a portion of the second major surface of the core. A thickness of the core may be defined by a distance between the first major surface and the second major surface. A thickness of the body may be defined by a distance between an exterior surface of the first facing and an exterior surface of the second facing. The thickness of the core may be greater than 85% of the thickness of the body. The core may include a composite having MgO and MgSO₄. A density of the composite may be substantially uniform across the entire thickness of the core.

According to some embodiments, a building panel may include a body. The body may include a first major surface, a second major surface opposite the first major surface, and a core between the first major surface and the second major surface. The core may include a composite having MgO and MgSO₄. The body may further include a tongue formed along a first edge portion of the body and a groove formed along a second edge portion of the body opposite the first edge portion of the body. A difference between a height of the groove and a height of the tongue may range from about 0.1 mm to about 15 mm.

According to some embodiments, a building panel may include a body. The body may include a first major surface, a second major surface opposite a first major surface, a slot formed in the first major surface and extending from the first major surface towards the second major surface, and a plurality of perforations formed in the second major surface and extending from the second major surface towards the first major surface. At least one perforation of the plurality of perforations may extend from the second major surface to a bottom end of the slot such that an air flow passageway may be formed between the first major surface and the second major surface through the slot and the at least one perforation.

According to some embodiments, a building panel system may include a first building panel and a second building panel. The first building panel may include a core having a side surface and a tongue extending from the side surface. The second building panel may include a core having an overhang and a groove defined at least in part by the overhang and configured to receive the tongue of the first building panel. At least one of the core of the first building panel or the core of the second building panel may include MgO and MgSO₄. The first building panel and the second building panel may be configured such that when the tongue of the first building panel is received in the groove of the second building panel, a first gap may be formed between the side surface of the first building panel and the overhang of the second building panel, and a second gap may be formed between the tongue of the first building panel and the overhang of the second building panel.

According to some embodiments, a building panel system may include a first building panel and a second building panel. The first building panel may include a core having a tongue 970. The second building panel may include a core having a groove configured to receive therein the tongue of the first building panel and at least portion of a mounting flange of a mounting member. At least one of the core of the first building panel or the core of the second building panel may include MgO and MgSO₄.

According to some embodiments, a building panel system may include a first building panel, a second building panel, and a mounting member. The first building panel may include a core having a tongue. The second building panel may include a core having a groove. The mounting member may include a mounting flange. At least one of the core of the first building panel or the core of the second building panel may include MgO and MgSO₄. The first building panel, the second building panel, and the mounting member may be configured such that the tongue of the first building panel and at least a portion of the mounting flange of the mounting member may be receivable in an overlapping configuration in the groove of the second building pane.

According to some embodiments, a method of forming a building panel may include forming a core of a body of a building panel. The core may include a first major surface, a second major surface opposite the first major surface, a thickness defined by a distance between the first major surface and the second major surface, and a volume defined at least in part by the first major surface and the second major surface. At least 95% of the volume of the core may be occupied by a composite including MgO and MgSO₄. The thickness of the core may be greater than 85% of a thickness of the body.

According to some embodiments, a method of forming a building panel may include forming a core. The core may include a first major surface and a second major surface opposite the first major surface. The method may further include providing a first facing to the first major surface of the core and providing a second facing to the second major surface of the core. The core may include a composite having MgO and MgSO₄. The core, the first facing, and the second facing may collectively form a body of the building panel. A thickness of the core may be greater than 85% of a thickness of the body. A density of the composite may be substantially uniform across the entire thickness of the core.

According to some embodiments, the present invention is directed to a method of installing a building panel system. The building panel system may include a first building panel, a second building panel, and a mounting member. The first building panel may include a core having an overhang and a groove defined at least in part by the overhang. The second building panel may include a core having a side surface and a tongue extending from the side surface. The mounting member may include a web and a mounting flange extending from the web. The method may include positioning the mounting flange of the mounting member inside the groove of the first building panel such that the overhang of the first building panel may rest upon the mounting flange of the mounting member. The method may further include positioning the tongue of the second building panel into the groove of the first building panel such that the mounting flange of the mounting member may be disposed between the overhang of the first building panel and the tongue of the second building panel, and the web of the mounting member may be disposed between a gap defined by the overhang of the first building panel and the side surface of the second building panel. At least one of the core of the first building panel or the core of the second building panel may include MgO and MgSO₄.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 schematically illustrates a top perspective view of a building panel according to some embodiments of the present invention.

FIG. 2A schematically illustrates a cross-sectional view of the building panel of FIG. 1, taken along line II-II in FIG. 1.

FIGS. 2B and 2C schematically illustrate patterns of perforations according to some embodiments of the present invention.

FIG. 3A schematically illustrates a top view of a building panel according to some embodiments of the present invention.

FIG. 3B schematically illustrates a side view of the building panel of FIG. 3A.

FIG. 3C schematically illustrates a close-up view of the area labeled IIIC in FIG. 3B.

FIG. 3D schematically illustrates a close-up view of the area labeled IIID in FIG. 3B.

FIG. 4 schematically illustrates a portion of a building panel system according to some embodiments of the present invention.

FIG. 5A schematically illustrates a portion of a building panel system according to some embodiments of the present invention.

FIG. 5B schematically illustrates a perspective view of a mounting member shown in FIG. 5A.

FIG. 6A schematically illustrates a portion of a building panel system according to some embodiments of the present invention.

FIG. 6B schematically illustrates a perspective view of a mounting member shown in FIG. 6A.

FIG. 7 schematically illustrates a portion of a building panel system according to some embodiments of the present invention.

FIGS. 8A and 8B schematically illustrate various building panels according to some embodiments of the present invention.

FIG. 9A schematically illustrates a front view of a building panel according to some embodiments of the present invention.

FIG. 9B schematically illustrates a back view of the building panel of FIG. 9A.

FIG. 9C schematically illustrates a cross-sectional view of the building panel of FIG. 9A, taken along line IXC-IXC in FIG. 9A.

FIG. 9D schematically illustrates a cross-sectional view of the building panel of FIG. 9A having an acoustical layer attached to the building panel.

FIG. 10 schematically illustrates a portion of a building panel system according to some embodiments of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” means less than about 0.1 wt. % based on the total of the referenced value.

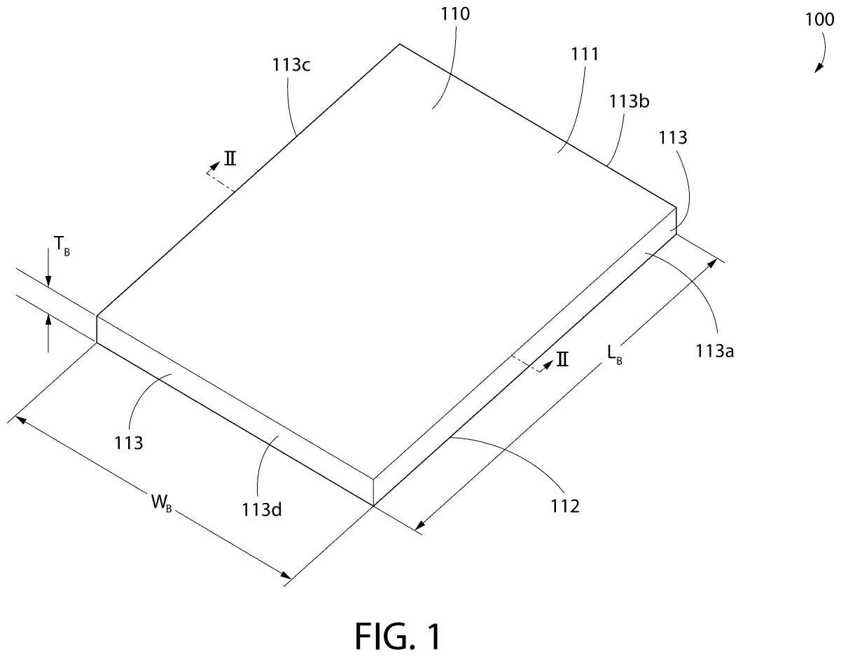

Referring to FIG. 1, a panel, such as a building panel 100, is illustrated in accordance with some embodiments of the present invention. The building panel 100 may include a body 110. The body 110 may include a first major surface 111, a second major surface 112 opposite the first major surface 111, and a side surface 113 extending between the first and second major surfaces 111, 112. The side surface 113 may also be referred to herein as a peripheral surface or a peripheral edge. The side surface 113 may include a first side surface 113a, a second side surface 113b adjacent the first side surface 113a, a third side surface 113c opposite the first side surface 113a, and a fourth side surface 113d opposite the second side surface 113b. In some embodiments, the first major surface 111, the second major surface 112, and/or the side surfaces 113a, 113b, 113c, 113d may form one or more exposed or exterior surfaces of the body 110 and/or exposed or exterior surfaces of the building panel 100. In some embodiments, the first major surface 111 of the body 110 may form a first major surface of the building panel 100, and the first major surface of the building panel 100 may be an exposed or exterior surface of the building panel 100. In some embodiments, the second major surface 112 of the body 110 may form a second major surface of the building panel 100 opposite the first major surface of the building panel 100. In some embodiments, the second major surface of the building panel 100 may be an exposed or exterior surface of the building panel 100. In some embodiments, the side surfaces 113a, 113b, 113c, 113d of the body 110 may form side surfaces of the building panel 100 extending between the first and second major surfaces of the building panel 100. In some embodiments, at least one of the side surfaces of the building panel 100 may be an exposed or exterior surface of the building panel 100.

In some embodiments, the body 110 may have a rectangular shape having a length L_{B} and a width W_{B} which may be the same as or different from the length L_{B}. However, the invention is not to be so limited in all embodiments and the body 110 may have other shapes in other embodiments, including square, triangular, other polygonal shapes, and even irregular shapes. A panel system, such as a building panel system including a wall and/or ceiling system, may include multiple panels having different body shapes. The multiple panels of different body shapes may couple or mate with one another to form coverage for a portion or an entirety of a wall and/or ceiling.

The length L_{B} of the body 110 may be defined by a distance between the second side surface 113b and the fourth side surface 113d. The length L_{B} of the body 110 may range from about 1 ft to about 12 ft—including all values and sub-ranges thereof. The width W_{B} of the body 110 may be defined by a distance between the first side surface 113a and the third side surface 113 c. The width W_{B} of the body 110 may range from about 0.25 ft to about 4.4 ft—including all values and sub-ranges thereof. A thickness T_{B} of the body 110 may be defined by a distance between the first major surface 111 and the second major surface 112.

In some embodiments, the first major surface of the building panel 100 may comprise the first major surface 111 of the body 110. In some embodiments, the second major surface of the building panel 100 may comprise the second major surface 112 of the body 110. In some embodiments, the side surfaces of the building panel 100 may comprise the side surfaces 113a, 113b, 113c, 113d of the body 110. In some embodiments, the length of the building panel 100 may be the same as or correspond to the length L_{B} of the body 110. In some embodiments, a width of the building panel 100 may be the same as or correspond to the width W_{B} of the body 110. In some embodiments, a thickness of the building panel 100 may be the same as or correspond to the thickness T_{B} of the body 110.

The length L_{B} of the body 110 may range from about 12 inches to about 144 inches including all values and sub-ranges thereof. The width W_{B} of the body 110 may range from about 3 inches to about 52 inches—including all values and sub-ranges thereof. The thickness T_{B} of the body 110 may range from about 2 mm to about 50 mm—including all values and sub-ranges thereof. For example, in some embodiments, the thickness of the body 110 may range from about 3 mm to about 7 mm, and in some embodiments, the thickness of the body 110 may range from about 8 mm to about 10 mm.

A ratio of the length L_{B} of the body 110 to the width W_{B} of the body 110 may range from about 40:1 to about 1:1—including all ratios and sub-ranges thereof. A ratio of the length L_{B} of the body 110 to the thickness T_{B} of the body 110 may range from about 1524:1 to about 6:1 including all ratios and sub-ranges thereof. A ratio of the width W_{B} of the body 110 to the thickness T_{B} of the body 110 may range from about 660:1 to about 1.5:1-including all ratios and sub-ranges thereof.

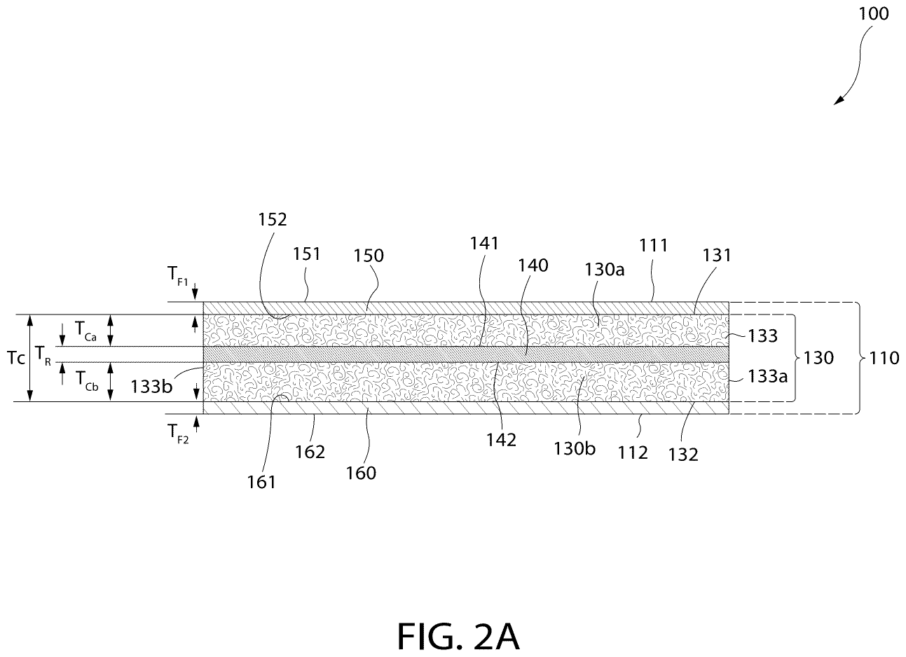

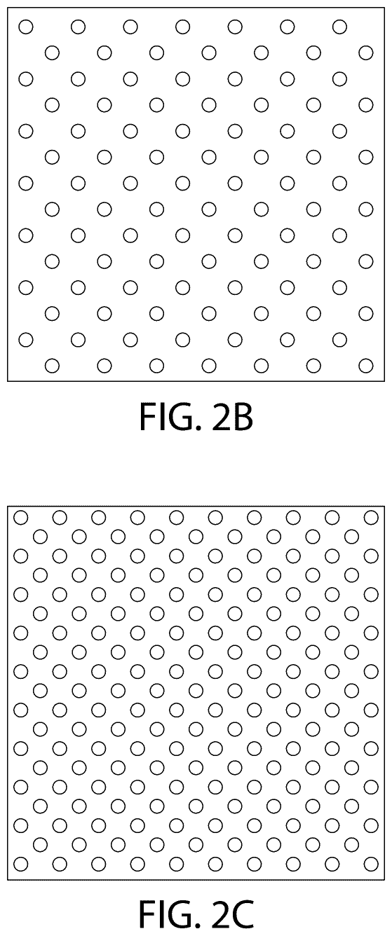

FIG. 2A illustrates a schematic cross-sectional view of the building panel 100 of FIG. 1. As shown in FIG. 2A, in some embodiments, the body 110 may include a multi-layered structure, and the layers may be formed of same or different materials or compositions. Although FIG. 2A illustrates a body having a multi-layered structure, in some embodiments, the body 110 of the building panel 100 may include a single layer that may be a monolithic, integral structure.

Referring to FIG. 2A, in some embodiments, the body 110 may include a core 130. The core 130 may include a first major surface 131, a second major surface 132 opposite the first major surface 131, and a side surface 133 extending between the first and second major surfaces 131, 132. The side surface 133 may also be referred to herein as a peripheral surface or a peripheral edge. The side surface 133 may include a first side surface 133a, a second side surface (not depicted in FIG. 2A) adjacent the first side surface 133a, a third side surface 133c opposite the first side surface 133a, and a fourth side surface (not depicted in FIG. 2A) opposite the second side surface 133b. In some embodiments, the side surface 133 of the core 130 may form at least a portion of the side surface 113 of the building panel 100. In some embodiments, the side surface 133 of the core 130 may form substantially the entire side surface 113 of the building panel 100.

In some embodiments, the entire first major surface 131 of the core 130 may be substantially planar and/or continuous. Similarly, in some embodiments, the entire second major surface 132 of the core 130 may be substantially planar and/or continuous. In some embodiments, the entire side surface 133 may be substantially planar and/or continuous. However, unevenness, such as openings, pores, and/or other features, may be present in the core 130 and may be present on one or more of the first major surface 131, the second major surface 132, and/or the side surface 133 of the core 130 resulting from manufacturing processes employed and/or the nature or properties of materials forming the core 130. Such openings and/or pores may not substantially affect the overall planar and/or continuous characteristics of the surfaces of the core 130. In some embodiments, one or more of the major and/or side surfaces of the core 130 may include features or structures that may be introduced or formed by design, as will be described herein in more detail. Such features or structures may alter or interrupt the planar and/or continuous characteristics of the respective surfaces.

The core 130 may include a thickness T_{C} defined by a distance between the first and second major surfaces 131, 132 of the core 130. The thickness T_{C} of the core 130 may range from about 2 mm to about 50 mm—including all values and sub-ranges thereof. In some embodiments, the thickness T_{C} of the core 130 may range from about 10% to about 100% of the thickness T_{B} of the body 110—including all values and sub-ranges thereof. In some embodiments, the thickness T_{C} of the core 130 may be greater than or about 85%, such as greater than or about 86%, greater than or about 88%, greater than or about 90%, greater than or about 92%, greater than or about 94%, greater than or about 96%, greater than or about 98%, or greater than or about 99%, of the thickness T_{B} of the body 110.

A length of the core 130 may be defined by a distance between the second and fourth side surfaces of the core 130, and a width of the core 130 may be defined by a distance between the first and third side surfaces 133a, 133c of the core 130. In some embodiments, the core 130 may include a length and a width that substantially correspond to the L_{B} and the width W_{B} of the body 110, respectively. In some embodiments, the length and/or the width of the core 130 may be different from the length L_{B} and/or the width W_{B} of the body 110. A ratio of the length of the core 130 to the width of the core 130 may range from about 40:1 to about 1:1—including all ratios and sub-ranges thereof. A ratio of the length of the core 130 to the thickness T_{C} of the core 130 may range from about 1524:1 to about 6:1—including all ratios and sub-ranges thereof. A ratio of the width of the core 130 to the thickness T_{C} of the core 130 may range from about 660:1 to about 1.5:1—including all ratios and sub-ranges thereof.

In some embodiments, the core 130 may include a composite forming the core 130. The composite may include magnesium oxide (MgO) and/or magnesium oxide (MgSO₄). In some embodiments, the composite and/or the core 130 may be substantially free of magnesium chloride (MgCl₂).

In some embodiments, MgO may be present in the composite in an amount ranging from about 50 wt. % to about 87 wt. % based on the total weight of composite forming the core 130 including all values and sub-ranges thereof. In some embodiments, MgO may be present in an amount of at least about 55 wt. %, such as greater than about 55 wt. %, based on the total weight of the composite forming the core 130. For example, in some embodiments, MgO may be present in an amount ranging from about 56 wt. % to about 87 wt. %, from about 60 wt. % to about 87 wt. %, from about 70 wt. % to about 87 wt. %, from about 56 wt. % to about 80 wt. %, or from about 56 wt. % to about 70 wt. %.

In some embodiments, MgSO4 may be present in the composite in an amount ranging from about 15 wt. % to about 45 wt. % based on the total weight of the composite forming the core 130 -including all values and sub-ranges thereof. In some embodiments, MgSO₄ may be present in an amount of at least about 25 wt. %, such as greater than about 27 wt. %, based on the total weight of the composite forming the core 130.

In some embodiments, the combination of MgO and MgSO4 may be present in an amount ranging from about 65 wt. % to about 98 wt. % based on the total weight of the composite forming the core 130-including all values and sub-ranges thereof. In some embodiments, the combination of MgO and MgSO₄ may be present in an amount of at least about 70 wt. %, such as greater than about 80 wt. %, based on the total weight of the composite forming the core 130. In some embodiments, the composite may include MgO and MgSO₄ in a molar ratio ranging from about 3.5:1 to about 18:1—including all ratios and sub-ranges thereof.

In some embodiments, the composite forming the core 130 may further include perlite. In some embodiments, perlite may be present in an amount ranging from about 1 wt. % to about 15 wt. % based on the total weight of the composite forming the core 130—including all values and sub-ranges thereof.

In some embodiments, the composite forming the core 130 may further include a fibrous component, such as natural and/or synthetic fibrous component. In some embodiments, the fibrous component may include a cellulosic fiber, such as a wood fiber, a bamboo fiber, or other natural fiber. In a non-limiting embodiment, the fibrous component may include a wood fiber, such as wood chips. In some embodiments, the fibrous component may be present in an amount ranging from about 1 wt. % to about 20 wt. % based on the total weight of the composite forming the core 130-including all values and sub-ranges thereof.

In some embodiments, the composite forming the core 130 may include no greater than or about 1% of oxide other than MgO (e.g., silica)-including all values and sub-ranges thereof. In some embodiments, the composite forming the core 130 may include no greater than or about 1% of chloride ions-including all values and sub-ranges thereof. In some embodiments, the composite forming the core 130 may include no greater than or about 1% of sodium ions including all values and sub-ranges thereof.

In some embodiments, a volume of the core 130 may be defined by the first major surface 131, the second major surface 132, and the side surface 133 of the core 130. In some embodiments, the composite forming the core 130 may be substantially homogenous, and a density of the composite forming the core 130 may be substantially uniform within the volume of the core 130 occupied by the composite. In some embodiments, the composite forming the core 130 may form a substantially homogenous and continuous body. However, voids, openings, or pores may be present in the composite forming the core 130 due to manufacturing processes employed and/or the nature or properties of materials forming the composite and/or the core 130. The density discussed herein thus refers to a bulk density of the composite, which is calculated based on a total volume occupied by the composite including both the volume occupied by the components forming the composites as well as the voids formed within the composite. In some embodiments, the density of the composite may vary within the volume of the core 130 occupied by the composite.

In some embodiments, the density of the composite may range from about 0.6 g/cm³ to about 1.8 g/cm³—including all values and sub-ranges thereof. For example, in some embodiments, the density of the composite may range from about 0.8 g/cm³ to about 1.6 g/cm³, from about 1.1 g/cm³ to about 1.4 g/cm³, or from about 1 g/cm³ to about 1.4 g/cm³. In some embodiments, the density of the composite may be less than 1.1 g/cm³ or less than 1 g/cm³ and may range from about 0.6 g/cm³ to about 1 g/cm³ or from about 0.8 g/cm³ to about 1 g/cm³.

In some embodiments, the core 130 may include a reinforcement member 140 disposed between the first major surface 132 and the second major surface 133 of the core 130. The reinforcement member 140 may include a first major surface 141 facing the first major surface 131 of the core 130. The reinforcement member 140 may further include a second major surface 142 facing the second major surface 132 of the core 130. In some embodiments, the reinforcement member 140 may include a mesh, woven, nonwoven, or solid member. For example, the reinforcement member 140 may include one or more of a fiberglass or felt mesh, metal wire mesh, fabric mesh, etc. Although FIG. 2A illustrates a single-layered reinforcement member 140, in some embodiments, the reinforcement member 140 may include a multilayered structure, and in some embodiments, the layers may be stacked together while in other embodiments, the layers may be disposed at various locations across the thickness T_{C} of the core 130.

In some embodiments, a thickness T_{R} of the reinforcement member 140 may range from about 0.5 mil to about 50 mils—including all values and sub-ranges thereof. In some embodiments, the thickness T_{R} of the reinforcement member 140 may range from about 0.02 % to about 64 % of the thickness T_{C} of the core 130—including all values and sub-ranges thereof. In some embodiments, a length of the reinforcement member 140 may substantially correspond to a length of the first major surface 131 of the core 130 and/or a length of the second major surface 132 of the core 130, which may substantially correspond to the length of the core 130 and/or the length L_{B} of the body 110. In some embodiments, a width of the reinforcement member 140 may substantially correspond to a width of the first major surface 131 of the core 130 and/or a width of the second major surface 132 of the core 130, which may substantially correspond to the width of the core 130 and/or the width W_{B} of the body 110.

With continued reference to FIG. 2A, the reinforcement member 140 may divide the core 130 into a first portion 130a and a second portion 130b. The first portion 130a may be disposed between the reinforcement member 140 and the first major surface 131 of the core 130, and the second portion 130b may be disposed between the reinforcement member 140 and the second major surface 132 of the core 130.

In some embodiments, a first density of the composite forming the first portion 130a of the core 130 may be substantially uniform within the volume of the first portion 130a of the core 130 occupied by the composite. In some embodiments, the first density may vary within the volume of the first portion 130a of the core 130 occupied by the composite. In some embodiments, a second density of the composite forming the second portion 130b of the core 130 may be substantially uniform within the volume of the second portion 130b of the core 130 occupied by the composite. In some embodiments, the second density may vary within the volume of the second portion 130b of the core 130 occupied by the composite. In some embodiments, the first density and the second density may be same. In some embodiments, the first density and the second density may be different.

A thickness T_{ca} of the first portion 130a may be defined by a distance between the first major surface 131 of the core 130 and the interface between the composite and the first major surface 141 of the reinforcement member 140. A thickness T_{Cb} of the second portion 130b may be defined by a distance between the second major surface 132 of the core 130 and the interface between the composite and the second major surface 142 of the reinforcement member 140. In some embodiments, the reinforcement member 140 may be disposed in the middle of the core 130 such that the thickness T_{Ca} of the first portion 130a and the thickness T_{Cb} of the second portion 130b may be substantially the same. In some embodiments, the reinforcement member 140 may be disposed closer to one of the first major surface 131 or the second major surface 132, and the thickness T_{Ca} of the first portion 130a and the thickness T_{Cb} of the second portion 130b may be different. A ratio of the thickness T_{Ca} of the first portion 130a to the thickness T_{Cb} of the second portion 130 b may range from 10:1 to 1:10.

As will be discussed in more detail below, in some embodiments, the body 110 may include a tongue or groove formed along one or more edge portions of the body 110. In some embodiments, the reinforcement member 140 may be positioned to extend into the tongue along the edge portion(s) of the body 110, thereby reinforcing the tongue. In some embodiments, the reinforcement member 140 may be positioned to extend into one or more overhangs defining the groove along the edge portion(s) of the body 110, thereby reinforcing the one or more overhangs forming the groove.

In some embodiments, at least 95%, at least 96%, at least 97%, at least 98%, or at least 99% of the volume of the core 130 may be occupied by the composite. In some embodiments, substantially the entire volume of the core 130 may be occupied by the composite. As mentioned above, voids, openings, or pores may be present in the composite and/or the core 130 due to manufacturing processes employed and/or the nature or properties of materials forming the composite. The percentages of volume of the core 130 occupied by the composite discussed herein refer to a bulk volume of the composite, including both the constituent materials forming the composite and the voids that may be formed within the composite due to the porous nature or properties of the composite. In some embodiments, a density of the core 130 may substantially correspond to the composite. In some embodiments, the density of the core 130 may be greater or less than the composite depending on the material and/or dimensions of the reinforcement member 140 utilized.

In some embodiments, the density of the core 130 may range from about 0.6 g/cm³ to about 1.8 g/cm³—including all values and sub-ranges thereof. For example, in some embodiments, the density of the core 130 may range from about 0.8 g/cm³ to about 1.6 g/cm³, from about 1.1 g/cm³ to about 1.4 g/cm³, or from about 1 g/cm³ to about 1.4 g/cm³. In some embodiments, the density of the core 130 may be less than 1.1 g/cm³ or less than 1 g/cm³ and may range from about 0.6 g/cm³ to about 1 g/cm³ or from about 0.8 g/cm³ to about 1 g/cm³.

In some embodiments, the density of the core 130 may be less than the composite due to perforations that may be formed in the core 130. In some embodiments, perforations, such as through holes, in the core 130 may form air passageways from and through the first major surface 131 of the core 130 to and through the second major surface 132 of the core 130 and vice versa. Such air passageways may improve the acoustical performance of the building panel 100. In some embodiments, the perforations may have a diameter ranging from about 0.5 mm to about 100 mm—including all values and sub-ranges thereof. For example, in some embodiments, the perforations may have a diameter ranging from, e.g., about 0.5 mm to about 50 mm, about 0.5 mm to about 40 mm, about 0.5 mm to about 30 mm, about 0.5 mm to about 20 mm, about 0.5 mm to about 10 mm, about 0.5 mm to about 8 mm, about 0.5 mm to about 6 mm, about 0.5 mm to about 4 mm, about 0.5 mm to about 2 mm, or about 0.5 mm to about 1 mm, to achieve desired acoustical performance and/or any other desired properties. In some embodiments, the perforations may have a uniform size (e.g., diameter). In some embodiments, the perforations may have non-uniform, varied sizes. A number of the perforations within each unit area of the core 130 may range from 1 perforation per ft² to 100 perforations per ft².

In some embodiments, the body 110 may further include a first facing 150. The first facing 150 may include a first major surface 151 and a second major surface 152 opposite the first major surface 151. In some embodiments, the first major surface 111 of the body 110 may include the first major surface 151 of the first facing 150. In some embodiments, the first major surface 151 of the first facing 150 may substantially correspond to the first major surface 111 of the body 110. In some embodiments, the first major surface 151 of the first facing 150 may form an exposed or exterior surface of the body 110 and/or the building panel 100. In some embodiments, the first facing 150 may be disposed over at least a portion of the first major surface 131 of the core 130. In some embodiments, the first facing 150 may be disposed over an entirety of the first major surface 131 of the core 130. The second major surface 152 of the first facing 150 and the first major surface 131 of the core 130 may partially or substantially overlap.

In some embodiments, the body 110 may further include a second facing 160. The second facing 160 may include a first major surface 161 and a second major surface 162 opposite the first major surface 161. In some embodiments, the second major surface 112 of the body 110 may include the second major surface 162 of the second facing 160. In some embodiments, the second major surface 162 of the second facing 160 may substantially correspond to the second major surface 112 of the body 110. In some embodiments, the second major surface 162 of the second facing 160 may form an exposed or exterior surface of the body 110 and/or the building panel 100. In some embodiments, the second facing 160 may be disposed over at least a portion of the second major surface 132 of the core 130. In some embodiments, the second facing 160 may be disposed over an entirety of the second major surface 133 of the core 130. The first major surface 161 of the second facing 160 and the second major surface 132 of the core 130 may partially or substantially overlap.

Although two facings 150, 160 are shown in FIG. 2A, in some embodiments, the building panel 100 may include only one facing, such as the first facing 150 or the second facing 160. In some embodiments, the building panel 100 may not include either the first facing 150 or the second facing 160.

In some embodiments, a thickness T_{F1} of the first facing 150 may be defined by a distance between the first major surface 151 and the second major surface 152 of the first facing 150. The thickness T_{F1} of the first facing 150 may range from about 1 mil to about 40 mils—including all values and sub-ranges thereof. In some embodiments, a thickness T_{F2} of the second facing 160 may be defined by a distance between the first major surface 161 and the second major surface 162 of the second facing 160. The thickness T_{F2} of the second facing 160 may range from about 1 mil to about 40 mils—including all values and sub-ranges thereof.

In some embodiments, the first facing 150 and/or the second facing 160 may include a single-layer structure. In some embodiments, the first facing 150 and/or the second facing 160 may include a multi-layer structure. In some embodiments, the first facing 150 and the second facing 160 may be of the same configuration, while in other embodiments, the first facing 150 and the second facing 160 may be configured differently.

In some embodiments, the one or more layers of the first facing 150 and/or the second facing 160 may include a preformed layer, such preformed layer may be attached or coupled to the first major surface 131 of the core 130, the second major surface 132 of the core 130, and/or one or more of the other layer(s) of the first facing 150 and/or the second facing 160 using a fastening mechanism, such as an adhesive, tape, staples, nails, screws, clips, hook and loop fasteners, or any other suitable fastening mechanism. In some embodiments, the one or more layers of the first facing 150 and/or the second facing 160 may be a coating formed by applying a coating material or composition to the first major surface 131 of the core 130, the second major surface 132 of the core 130, and/or one or more of the layer(s) of the first facing 150 and/or the second facing 160.

In some embodiments, the one or more layers of the first facing 150 and/or the second facing 160 may include perforations or through holes. In some embodiments, the perforations may define air passageways in the first facing 150 and/or the second facing 160. In some embodiments, the perforations may define air passageways from and through the first major surface 151 of the first facing 150 to and through the second major surface 152 of the first facing 150 and vice versa. In some embodiments, the perforations may define air passageways from through the first major surface 161 of the second facing 160 to and through the second major surface 162 of the second facing 160 and vice versa. Such air passageways may improve the acoustical performance of the building panel 100.

The size of the perforations may be the same or different in the first facing 150 and/or the second facing 160. In some embodiments, the perforations may have a diameter ranging from about 50 mils to about 4 inches-including all values and sub-ranges thereof. For example, in some embodiments, the perforations may have a diameter ranging from, e.g., about 50 mils to about 2 inches, about 50 mils to about 1.5 inches, about 50 mils to about 1 inches, about 50 mils to about 750 mils, about 50 mils to about 500 mils, about 50 mils to about 250 mils, or about 50 mils to about 100 mils, to achieve desired acoustical performance and/or any other desired properties. In some embodiments, the perforations may have a uniform size (e.g., diameter). In some embodiments, the perforations may have non-uniform, varied sizes. A number of the perforations within each unit area of the first facing 150 and/or the second facing 160 may range from 1 per ft² to 100 per ft². FIGS. 2B and 2C schematically illustrate some non-limiting exemplary patterns of perforations that may be formed in the first facing 150, the second facing 160, and/or the core 130 as discussed above, according to some embodiments. A ratio of the spacing between adjacent perforations to a diameter of the perforations may range from about 8:1 to about 2:1. The open area, i.e., the area of the surface of the first facing 150, the second facing 160, or the core 130 that may be occupied by the perforations may range from about 5% to about 50%—including all values and sub-ranges thereof—of the surface area of the first facing 150, the second facing 160, or the core 130.

In some embodiments, the first facing 150 and/or the second facing 160 may impart and/or improve certain properties of the building panel 100. In some embodiments, the one or more layers of the first facing 150 and/or the second facing 160 may include a fire or flame retarding layer or coating. In some embodiments, the one or more layers of the first facing 150 and/or the second facing 160 may include a water resistance layer or coating that may allow the building panel 100 to be washed or cleaned. In some embodiments, the one or more layers of the first facing 150 and/or the second facing 160 may provide excellent mold growth resistance. In some embodiments, the one or more layers of the first facing 150 and/or the second facing 160 may include a scratch-resistant layer or coating. In some embodiments, the one or more layers of the first facing 150 and/or the second facing 160 may include a decorative layer or coating that may enhance the aesthetics of the building panel 100. In some embodiments, the one or more layers of the first facing 150 and/or the second facing 160 may be transparent, semi-transparent, translucent, or opaque.

In some embodiments, the one or more layers of the first facing 150 and/or the second facing 160 may include a melamine-based material, a low pressure laminate (LPL), a high pressure laminate (HPL), a scrim, a film, a coating, an ink layer, a veneer, paper, etc., and a combination thereof. The one or more layers of the first facing 150 and/or the second facing 160 may be selected such that the first facing 150 and the second facing 160 may have similar elongation properties to minimize uneven stress on the core 130 and/or the deflection of the core 130 that may be caused due to such uneven stress.

As discussed above, the first facing 150, the second facing 160, and/or the core 130 may be porous and/or may include perforations formed therein, which may define air passageways and/or allow airflow. The air flow may result in the building panel 100 capable of exhibiting acoustical performance—thereby allowing the building panel 100 to function as an acoustical building panel.

In some embodiments, the airflow may allow the building panel to exhibit noise reducing characteristics quantified by a Noise Reduction Coefficient (NRC) rating, as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

In some embodiments, the building panel 100 may exhibit an NRC of at least about 0.30 as measured between the first major exposed surface and the second major exposed surface of the building panel 100. In some embodiments, the building panel 100 have an NRC ranging from about 0.30 to about 0.95—including all values and sub-ranges there-between.

Depending on the size and/or number of perforations, any suitable or desired air flow resistance of the building panel 100, as measured between the first major exposed surface and the second major exposed surface, may be achieved.

As discussed above, the core 130 may include MgO and/or MgSO₄, which may allow the building panel 100 to exhibit excellent fire retardancy. In some embodiments, the first facing 150 and/or the second facing 160 may include a fire or flame retarding layer or coating. Thus, the building panel 100 discussed herein may have a Class A fire rating based on ASTM E-84 testing.

The configuration of the building panel 100, including but not limited to, incorporation of one or more of the reinforcement member 140, the first facing 150, and/or the second facing 160, may further allow the body 110 and/or the building panel 100 to have a relatively thin, and thus lightweight, construction while exhibiting excellent strength, integrity, and/or durability. In some embodiments, a warpage of the body 110 and/or the building panel 100 may be less than about 20 mm, less than about 15 mm, less than about 10 mm, less than 5 mm, less than about 3 mm, less than about 2 mm, less than about 1.5 mm, less than about 1.2 mm, less than about 1 mm, or less than about 0.5 mm, as measured in accordance with center sag testing. Specifically, the building panel 100 may be supported along its edges, and the center sag of the building panel 100 due to gravity may be measured using a caliper.

Referring back to FIGS. 1 and 2, in some embodiments, the side surfaces 113, 133 of the body 110 and/or the core 130 may be substantially perpendicular to the major surfaces 111, 112, 131, 132 of the body 110 and/or the core 130. In some embodiments, one or more of the first, second, third, and/or fourth side surfaces 113a-d, 133a-d of the body 110 and/or the core 130 may be slanted relative to the major surfaces 111, 112, 131, 132 of the body 110 and/or the core 130.

In some embodiments, the body 110 and/or the core 130 may include side surfaces 113, 133 that may be substantially planar or flat. In some embodiments, the one or more of the first, second, third, and/or fourth side surfaces 113a-d, 133a-d of the body 110 and/or the core 130 may include features facilitating the incorporation or installation of one or more of the building panels 100 into a building panel system, including but not limited to, a ceiling system, a wall system, etc.

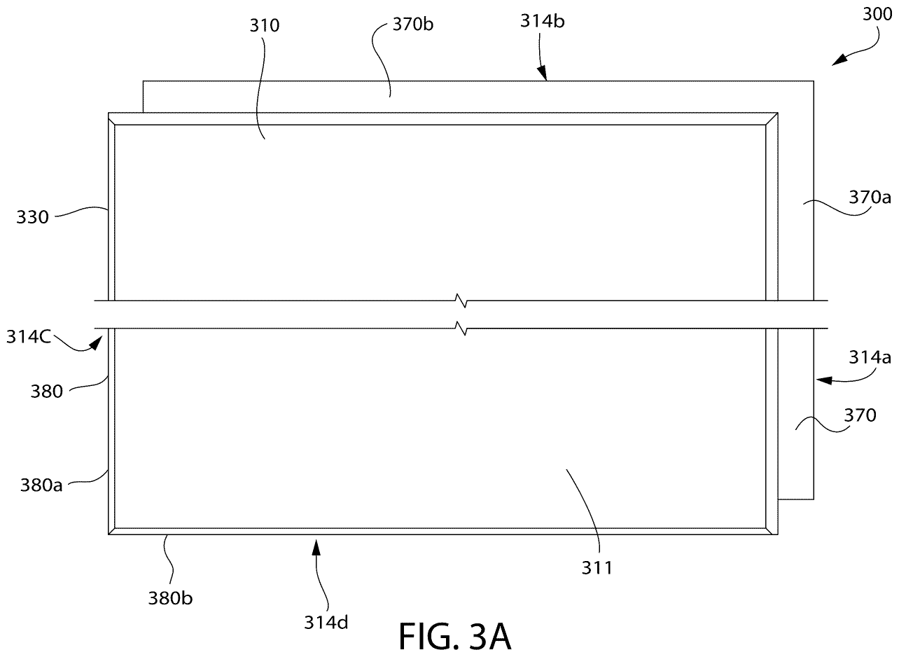

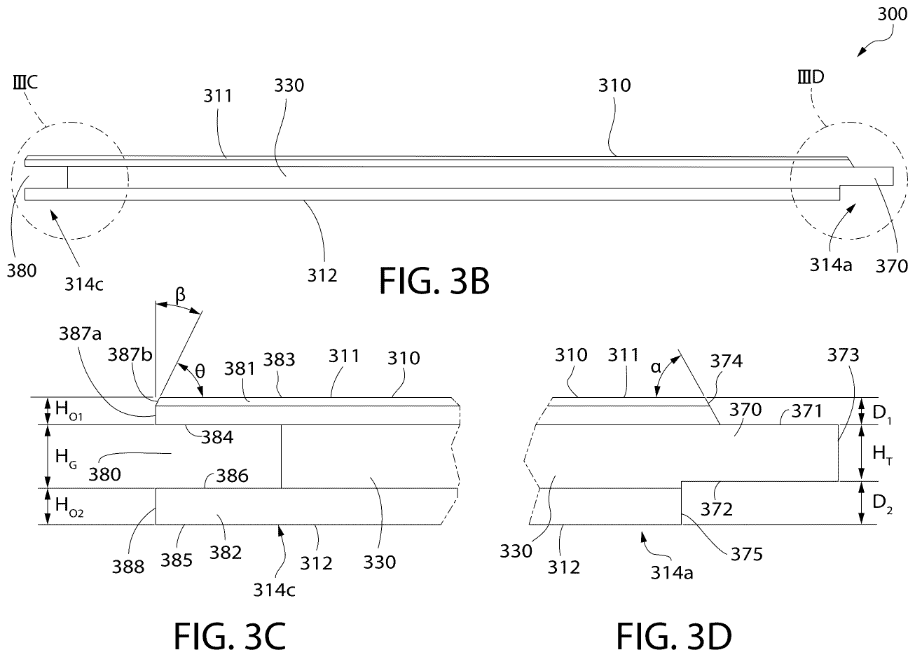

With reference to FIGS. 3-8, additional side surface and/or edge details of the building panel will be described. For clarify purpose, some of the figures may not illustrate all the construction details of the various building panels described herein. Nonetheless, it is understood that any of the building panels described herein may include the same or similar features as illustrated and/or described with respect any other building panels. For example, any of the building panels may include a body, and the body may include one or more of a core, a reinforcement member disposed in the core, a first facing disposed on one side of the core, and/or a second facing disposed on the opposite side of the core. The core, reinforcement member, first facing, and/or second facing may be similar to or substantially the same as those described herein with reference to FIGS. 1 and 2.

FIGS. 3A and 3B schematically illustrate a top view and a side view of a building panel 300, respectively, according to some embodiments of the present invention. FIG. 3C schematically illustrates a close-up view of the area labeled IIIC in FIG. 3B. FIG. 3D schematically illustrates a close-up view of the area labeled IIID in FIG. 3B.

The building panel 300 may include a body 310. The body 310 may be similar to the body 110 described above with reference to FIGS. 1 and 2. The body 310 may include a first major surface 311 and a second major surface 312 opposite the first major surface 311. In some embodiments, the body 310 may include a core 330, a reinforcement member, a first facing, and/or a second facing, some of which are not depicted for purpose of clarity.

The body 310 may include a tongue 370 formed along one or more edge portions 314 of the body 310. In some embodiments, the tongue 370 may include a first tongue 370a formed along a first edge portion 314a of the body 310. In some embodiments, the tongue 370 may further include a second tongue 370b formed along a second edge portion 314b adjacent to the first edge portion 314a of the body 310. In some embodiments, the first tongue 370a and the second tongue 370b may meet at a corner region of the body 310 and may form a continuous tongue 370 along the first edge portion 314a and the second edge portion 314b of the body 310. In some embodiments, the first tongue 370a and the second tongue 370b may be formed as separate pieces that may not connect at the corner region of the body 310.

In some embodiments, the body 310 may include a groove 380 formed along one or more edge portions 314 of the body 310. In some embodiments, the groove 380 may include a first groove 380a formed along a third edge portion 314c of the body 310 opposite the first edge portion 314a of the body 310. In some embodiments, the groove 380 may further include a second groove 380b formed along a fourth edge portion 314d adjacent to the third edge portion 314c and opposite the second edge portion 314b of the body 310. In some embodiments, the first groove 380a and the second groove 380b may meet at a corner region of the body 310 and may form a continuous groove 380 along the third edge portion 314c and the fourth edge portion 314d of the body 310. In some embodiments, the first groove 380a and the second groove 380b may be formed as separate grooves that may not connect at the corner region of the body 310.

The groove 380 of the building panel 300 may be configured to receive therein the tongue 370 of another building panel 300 such that two or more of the building panels 300 may couple or mate with one another to form coverage for a portion or an entirety of a wall and/or ceiling.

In some embodiments, the tongue 370 and/or the groove 380 may be formed or defined by the core 330. In some embodiments, at least a portion of the tongue 370 and/or the groove 380 may be formed or defined in part by the core 330, the reinforcement member, the first facing, and/or the second facing.

With reference to FIG. 3D, in some embodiments, the tongue 370 may include a first surface 371 and a second surface 372 opposite the first surface 371 of the tongue 370. In some embodiments, the first surface 371 and/or the second surface 372 of the tongue 370 may be substantially planar and substantially parallel to each other.

A height HT of the tongue 370 may be defined by a distance between the first surface 371 and the second surface 372 of the tongue 370. The height H_{T} of the tongue 370 may range from about 1.3 mm to 25 mm—including all values and sub-ranges thereof. The tongue 370 may include a side surface 373 defining a terminal end of the tongue 370.

In some embodiments, the body 310 and/or the core 330 may include a first side surface 374 extending between the first surface 371 of the tongue 370 and the first major surface 311 of the body 310. In some embodiments, the first side surface 374 of the body 310 and/or the core 330 may be sloped relative to the first major surface 311 of the body 310. The first side surface 374 of the body 310 and/or the core 330 may be sloped relative to the first major surface 311 of the body 310 at an angle α ranging from about 20 degrees to about 90 degrees—including all values and sub-ranges thereof. It should be noted that any two surfaces (or extensions thereof) may define (or may be sloped relative to each other at) an acute angle, a right angle, or an obtuse angle. As used herein, if two surfaces do not form a right angle, the angle between two surfaces refers to the acute angle formed by the two surfaces instead of the supplementary obtuse angle formed by the two surfaces. For example, two surfaces may form an acute angle of 50 degrees and a supplementary obtuse angle of 130 degrees, the angle between the two surfaces described herein refers to the acute angle of 50 degrees instead of the supplementary obtuse angle of 130 degrees.

The body 310 and/or the core 330 may further include a second side surface 375 extending between the second surface 372 of the tongue 370 and the second major surface 312 of the body 310. In some embodiments, the second side surface 375 may be substantially perpendicular to the second major surface 312 of the body 310 and/or the second surface 372 of the tongue 370. In some embodiments, the first side surface 374 of the body 310 and/or the core 330 may be substantially perpendicular to the first major surface 311 of the body 310 and/or the first surface 371 of the tongue 370. In some embodiments, the first and second side surfaces 374, 375 of the body 310 and/or the core 330 may be substantially coplanar or vertically aligned. In some embodiments, the second side surface 375 of the body 310 and/or the core 330 may be sloped relative to the second major surface 312 of the body 310.

A width of the first surface 371 of the tongue 370 may extend between the first side surface 374 of the body 310 and/or the core 330 and the side surface 373 of the tongue 370. A width of the second surface 372 of the tongue 370 may extend between the second side surface 375 of the body 310 and/or the core 330 and the side surface of the tongue 370. In some embodiments, the width of the first surface 371 of the tongue 370 may be different from the width of the second surface 372 of the tongue 370. In some embodiments, the width of the first surface 371 of the tongue 370 may be less than the width of the second surface 372 of the tongue 370. In these embodiments, when the tongue 370 of a first building panel 300 is received in the groove 380 of a second building panel 300, a gap may be formed between the second side surface 375 of the first building panel 300 and the second building panel 300 to accommodate a portion of mounting member, as will be described in more detail below. In some embodiments, a difference between the width of the first surface 371 of the tongue 370 and the width of the second surface 372 of the tongue 370 may range from about 1 mm to about 20 mm-including all values and sub-ranges thereof.

A width of the tongue 370 may be defined by the lesser of the width of the first surface 371 of the tongue 370 or the width of the second surface 372 of the tongue 370. The width of the tongue 370 may range from about 3 mm to about 25 mm—including all values and sub-ranges thereof. In some embodiments, a ratio of the width of the tongue 370 to the height H_{T} of the tongue 370 may range from 0.05:1 to 20:1—including all values and sub-ranges thereof. For example, in some embodiments, the ratio of the width of the tongue 370 to the height H_{T} of the tongue 370 may range from 7:1 to 1:1. In some embodiments, a ratio of the thickness of the core 330 or the body 310 to the height H_{T} of the tongue 370 may range from 5:1 to 3:1—including all values and sub-ranges thereof. For example, in some embodiments, the ratio of the thickness of the core 330 or the body 310 to the height H_{T} of the tongue 370 may range from 3:1 to 2:1.

With reference to FIG. 3C, in some embodiments, the body 310 and/or the core 330 may include a first overhang 381 and a second overhang 382. In some embodiments, the first overhang 381 and the second overhang 382 may define at least in part the groove 380. The first overhang 381 may include an outer surface 383 and an inner surface 384 opposite the outer surface 383 of the first overhang 381. The outer surface 383 of the first overhang 381 may form a portion of the first major surface 311 of the body 310. The second overhang 382 may include an outer surface 385 and an inner surface 38 opposite the out surface of the second overhang 382. The outer surface 385 of the second overhang 382 may form a portion of the second major surface 312 of the body 310. The inner surface 384 of the first overhang 381 and/or the inner surface 385 of the second overhang 382 may be substantially planar and may be substantially parallel to each other. A height HG of the groove 380 may be defined by a distance between the inner surface 384 of the first overhang 381 and the inner surface 386 of the second overhang 382.

In some embodiments, the first overhang 381 may include one or more side surfaces 387 extending between the outer surface 383 and the inner surface 384 of the first overhang 381. In some embodiments, the first overhang 381 may include a first side surface 387a and a second side surface 387b. The first side surface 387a may be substantially perpendicular to the inner surface 384 of the first overhang 381, the outer surface 383 of the first overhang 381, and/or the first major surface 311 of the body 310. The second side surface 387b may be sloped relative to the first side surface 387a of the first overhang 381. Thus, a corner defined by the first side surface 387a of the first overhang 381 and the outer surface 383 of the first overhang 381 may be beveled or chamfered. The bevel or chamfer may define a sloped edge or surface (e.g., the second side surface 387b) between the first side surface 387a of the first overhang 381 and the outer surface 383 of the first overhang 381. The second side surface 387b may be sloped relative to the first side surface 387a of the first overhang 381 at an angle β ranging from about 0 degrees to about 70 degrees—including all values and sub-ranges thereof, and the second side surface 387b may be sloped relative to the outer surface 383 of the first overhang 381 (or the first major surface 311 of the body 310) at an angle θ ranging from about 20 degrees to about 90 degrees.

In some embodiments, the slope of the second side surface 387b of the first overhang 381 relative to the first major surface 311 of the body 310 may be substantially the same as the slope of the first side surface 374 of the body 310 relative to the first major surface of the body 310. In some embodiments, the slope of the second side surface 387b of the first overhang 381 relative to the first major surface 311 of the body 310 may be different from the slope of the first side surface 374 of the body 310 relative to the first major surface of the body 310.

In some embodiments, the second overhang 382 may include a side surface 388 extending between the outer surface 385 and the inner surface 386 of the second overhang 382. In some embodiments, the side surface 388 of the second overhang 382 and the first side surface 387a of the first overhang 381 may be substantially coplanar or vertically aligned. In some embodiments, the side surface 388 of the second overhang 382 may be substantially perpendicular to the inner surface 386 of the second overhang 382, the outer surface 385 of the second overhang 382, and/or the second major surface 312 of the body 310.

With continued reference to FIGS. 3C and 3D, in some embodiments, the first surface 371 of the tongue 370 may be offset from the first major surface 311 of the body 310 by a vertical distance D₁ that may substantially correspond to a height H_{O1} of the first overhang 381. The height H_{O1} of the first overhang 381 may be defined by a distance between the first major surface 311 of the body 310 (or the outer surface 383 of the first overhang 381) and the inner surface 384 of the first overhang 381. The second surface 372 of the tongue 370 may be offset from the second major surface 312 of the body 310 by a vertical distance D₂ that may be greater than a height H_{O2} of the second overhang 382. The height H_{O2} of the second overhang 382 may be defined by a distance between the second major surface 312 of the body 310 (or the outer surface 385 of the second overhang 382) and the inner surface 386 of the second overhang 382. In these embodiments, when the groove 380 of a first building panel 300 receives therein the tongue 370 of a second building panel 300, a gap may be formed between the second overhang 382 of the first building panel 300 and the tongue 370 of the second building panel 300, while the first major surfaces 311 of the first and second building panels 300 may be substantially coplanar, and the second major surfaces 312 of the first and second building panels 300 may also be substantially coplanar.

In some embodiments, the height H_{T} of the tongue 370 may range from 1.3 mm to 25 mm—including all values and sub-ranges thereof. In some embodiments, the height H_{G} of the groove 380 may range from 1.5 mm to 30 mm—including all values and sub-ranges thereof. In some embodiments, the height H_{G} of the groove 380 may be greater than the H_{T} of the tongue 370. In some embodiments, a difference between the height H_{G} of the groove 380 and the height H_{T} of the tongue 370 may range from about 0.1 mm to about 15 mm—including all values and sub-ranges thereof. For example, in some embodiments, the difference between the height H_{G} of the groove 380 and the height H_{T} of the tongue 370 may range from about 0.1 mm to about 15 mm or from about 0.2 mm to about 4 mm. In some embodiments, a difference between the height H_{G} of the groove 380 and the height H_{T} of the tongue 370 may be at least or about 0.1 mm, such as greater than or about 0.2 mm or greater than or about 0.5 mm. In some embodiments, the height H_{G} of the groove 380 may be greater than the height H_{T} of the tongue 370 by from about 2% to about 100% (including all values and sub-ranges thereof) of the height H_{T} of the tongue 370. For example, in some embodiments, the height H_{G} of the groove 380 may be greater than the height H_{T} of the tongue 370 by from about 5% to about 100% or from about 5% to about 70%. In some embodiments, a ratio of the height H_{G} of the groove 380 to the height H_{T} of the tongue 370 may range from about 1.05:1 to about 2:1—including all values and sub-ranges thereof.

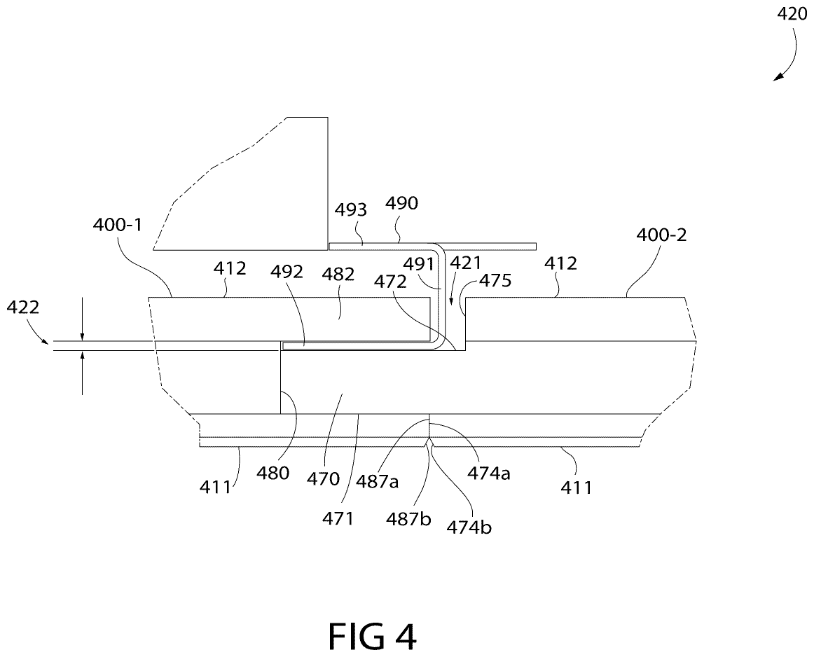

FIG. 4 schematically illustrates a portion of a building panel system 420 including one or more building panels 400 according to some embodiments of the present invention. The panel system 420 may include a first building panel 400-1, a second building panel 400-2 coupled or mated to the first building panel 400-1, and at least one mounting member 490 for coupling or attaching the first and second panels 400-1, 400-2 to a ceiling and/or a wall. The building panel 400 may be similar to the building panel 100, 300 describe above. Similar numbering scheme will be used for the building panel 400 as with building panel 100, 300 except that the 400-series of numbers will be used.

In some embodiments, the building panel 400 may differ from the building panel 300 in that the building panel 400 may include two side surfaces, e.g., a side surface 474a that may be substantially vertical and a sloped side surface 474b, extending between the first major surface 411 of the building panel 400 and the tongue 470. The vertical side surface 474a and the sloped side surface 474b may define a bevel or chamfer similar to the bevel or chamfer defined by the side surfaces 487a, 487b of the first overhang 381 of the building panel 400. When the first building panel 400-1 and the second building panel 400-2 are coupled to each other, the side surfaces 474a, 487a may be in an abutting relationship, while the first major surfaces 411 of the first and second building panels 400-1, 400-2 may be substantially coplanar, and the second major surfaces 412 of the first and second building panels 400-1, 400-2 may also be substantially coplanar.

As discussed above, the width of the first surface 471 of the tongue may be less than the width of the second surface 472 of the tongue such that when the tongue 470 of the second building panel 400-2 is received within the groove 480 of the first building panel 400-1, a first gap 421 may be formed between the side surface 475 of the second building panel 400-2 and the second overhang 482 of the first building panel 400-1.

As also discussed above, the groove 480 of the first building panel 400-1 may be configured to receive the tongue 470 of the second building panel 400-2. The height of the groove 480 may be greater than the height of the tongue 470 such that when the tongue 470 of the second building panel 400-2 is received within the groove 480 of the first building panel 400-1, a second gap 422 may be formed between the second overhang 482 of the first building panel 400-1 and the tongue 470 of the second building panel 400-2.

With continued reference to FIG. 4, the mounting member 490 may include a web 491 and a mounting flange 492 extending from the web 491. When the tongue 470 of the second building panel 400-2 is received in the groove 480 of the first building panel 400-1, at least a portion of the web 491 of the mounting member 490 may be received in the first gap 421, and at least a portion of the mounting flange 492 of the mounting member 490 may be received in the second gap 422. In some embodiments, substantially the entire mounting flange 492 of the mounting member 490 may be received in the second gap 422. The tongue 470 of the second building panel 400-2 and the mounting flange 492 of the mounting member 490 may be received in the groove 480 of the first building panel 400-1 in an overlapping configuration. In some embodiments, the tongue 470 of the second building panel 400-2 and the mounting flange 492 of the mounting member 490 may be received in the groove 480 of the first building panel 400-1 in a substantially parallel configuration. In some embodiments, the mounting member 490 may further include a base 493, such as a base plate or mounting plate, from which the web 491 may extend. The base 493 may be configured for coupling to a support structure, such as a ceiling and/or wall mounting grid, such that the building panels 400 may be secured to and may form coverage for a portion or an entirety of a wall and/or ceiling.

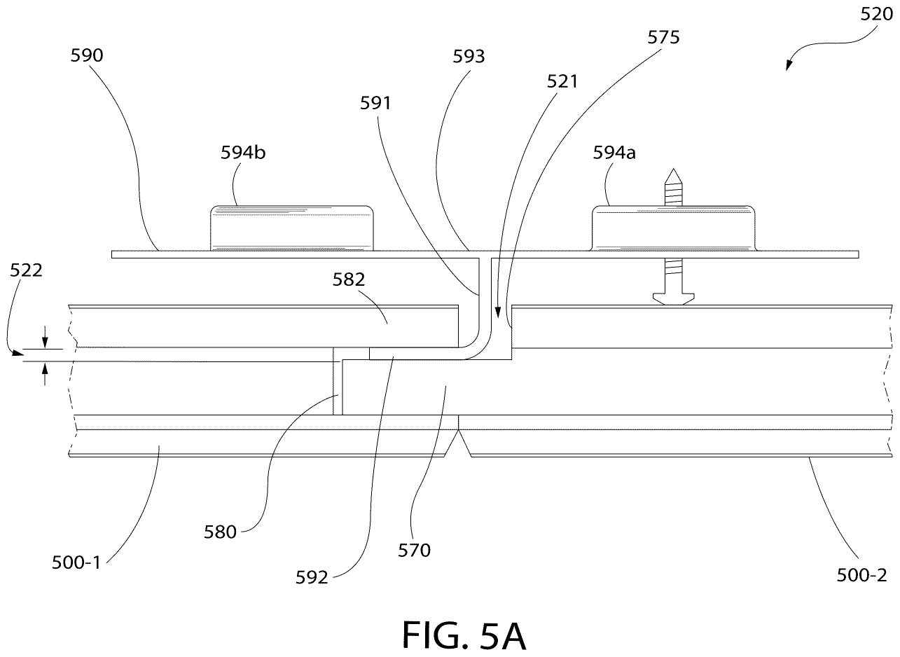

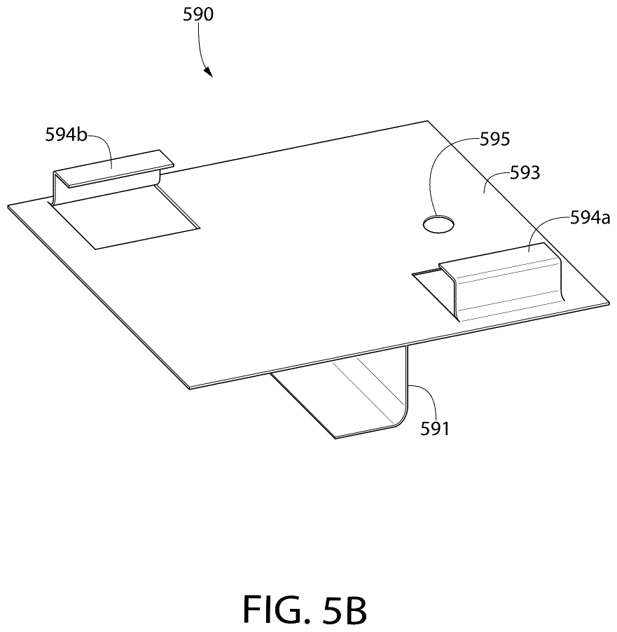

FIG. 5A schematically illustrates a portion of a building panel system 520 including one or more building panels 500 according to some embodiments of the present invention. The panel system 520 may include a first building panel 500-1, a second building panel 500-2 coupled or mated to the first building panel 500-1, and at least one mounting member 590 for coupling or attaching the first and second panels 500-1, 500-2 to a ceiling and/or a wall via a support structure, such as a ceiling/wall mounting grid. The building panel 500 may be similar to the building panel 100, 300, 400 describe above. Similar numbering scheme will be used for the building panel 500 as with building panel 100, 300, 400 except that the 500-series of numbers will be used.

As shown in FIG. 5A, when the tongue 570 of the second building panel 500-2 is received in the groove 580 of the first building panel 500-1, a first gap 521 may be formed between the side surface 575 of the second building panel 500-2 and the overhang 582 of the first building panel 500-1, and a second gap 522 may be formed between the overhang 582 of the first building panel 500-1 and the tongue 570 of the second building panel 500-2. The mounting member 590 may include a base 593, such as a base plate or mounting plate, a web 591 extending from the base 593, and a mounting flange 592 extending from the web 591. At least a portion of the web 591 of the mounting member 590 may be received in the first gap 521, and at least a portion of the mounting flange 592 of the mounting member 590 may be received in the second gap 522. In some embodiments, substantially the entire mounting flange 592 of the mounting member 590 may be received in the second gap 522.

FIG. 5B schematically illustrates a perspective view of the mounting member 590 shown in FIG. 5A. With reference to FIGS. 5A and 5B, in some embodiments, the mounting member 590 may further include a first arm 594a extending from the base 593 and disposed along or near a first side or edge of the base 593, and a second arm 594b extending from the base 593 and disposed along or near a second side or edge of the base 593 opposite the first side or edge. The first arm 594a and/or the second arm 594b may extend along a portion or an entirety of the first and/or second sides or edges of the base 593. In some embodiments, the first arm 594a and the second arm 594b may be offset from each other along the sides or edges of the base 593. For example, the base 593 may include two portions extending from opposite sides of the web 591, and the first arm 594a may be disposed along or near a side or edge of one portion and the second arm 594b may be disposed along or near a side or edge of the other portion.

The first arm 594a and/or the second arm 594b may each define a slot. The slots may be configured to receiving therein opposite edge portions of a support structure for attaching the mounting member 590 and the building panels 500 to the support structure. The mounting member 590 may further include an aperture 595. A fastener, such as a screw, bolt, etc., may be positioned through the aperture 595 for further securing the mounting member 590 to the support structure.

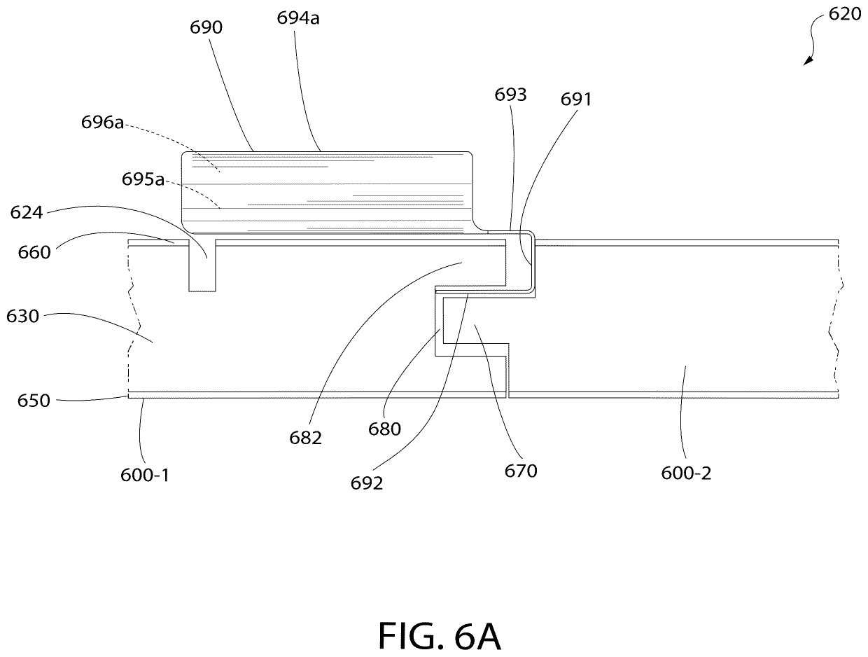

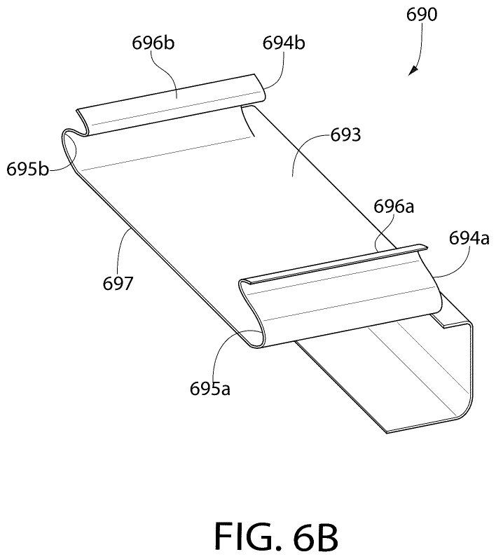

FIG. 6A schematically illustrates a portion of a building panel system 620 including one or more building panels 600 according to some embodiments of the present invention. The panel system 620 may include a first building panel 600-1, a second building panel 600-2 coupled or mated to the first building panel 600-1, and at least one mounting member 690 for coupling or attaching the first and second panels 600-1, 600-2 to a ceiling and/or a wall via a support structure, such as a ceiling/wall mounting grid. The building panel 600 may be similar to the building panel 100, 300, 400, 500 describe above. Similar numbering scheme will be used for the building panel 600 as with building panel 100, 300, 400,500 except that the 600-series of numbers will be used.

As shown in FIG. 6A, when the tongue 670 of the second building panel 600-2 is received in the groove 680 of the first building panel 600-1, a portion of the web 691 of the mounting member 690 may be received in a first gap defined by side surfaces of the first and second building panels 600-1, 600-2, and a portion of the mounting flange 692 of the mounting member 690 may be received in a second gap in the groove 680 defined by the overhang 682 of the first building panel 600-1 and the tongue 670 of the second building panel 600-2.

FIG. 6B schematically illustrates a perspective view of the mounting member 690 shown in FIG. 6A. With references to FIGS. 6A and 6B, in some embodiments, the mounting member 690 may include a first arm 694a and a second arm 694b disposed on opposite sides or edges of a base 693, such as a base plate or mounting plate. The first arm 694a and/or the second arm 694a may extend along a portion or substantially the entire sides or edges of the base 693. In some embodiments, the first arm 694a and/or the second arm 694b may extend to a terminal end 697 of the base 693. The first arm 694a and/or the second arm 694b may be aligned with each other along the extension of the base 693.

The first arm 694a and/or the second arm 694b may each define an inward facing channel 695a, 695b and a lead-in surface 696a, 696b angled outwardly. When installing the mounting member 690 to a support structure, the lead-in surfaces 696a, 696b may be pushed against the support structure, such as a mounting flange of the support structure, causing the first and second arms 694a, 694b to temporarily bend outwardly until the mounting flange of the support structure may be received in the inward facing channels 695. The first and second arms 694a, 694b may return to their origin positions, coupling or securing the mounting member 690 to the support structure. In some embodiments, the inward facing channels 695a, 695b may be configured to allow the mounting member 690 to move or slide along the support structure after the mounting member 690 has been coupled or secured to the support structure. In some embodiments, the mounting member 690 may further include an aperture. A fastener, such as a screw, bolt, etc., may be positioned through the aperture for further securing the mounting member 690 to the support structure.

With further reference to FIG. 6A, in some embodiments, the building panel 600 may further include one or more slots 624. In some embodiments, the slots 624 may be formed on one or both sides of the building panel 600. The slots 624 may be formed through the first and/or second facings 650, 660 of the building panel 600 and/or may be formed into at least a portion of the core 630 of the building panel 600. The slots 624 may be formed along a length (or a longitudinal dimension) of the building panel 600 and/or a width (or a transverse dimension) of the building panel 600. In some embodiments, the slots 624 may be angled relative to the longitudinal and/or transverse dimensions of the building panel 600.

In some embodiments, a length of the slots 624 may extend along a portion of the length and/or width the building panel 600. In some embodiments, the length of the slots 624 may extend along the entire length and/or width of the building panel 600 such that passages from one side surface of the building panel 600 to an opposite side surface of the building panel 600 may be formed by the slots 624. A ratio of a thickness of the building panel 600 to a depth of the slots 624, which may be defined as the extension of the slots 624 from the major surface of the building panel 600 into the core of building panel 600, may range from about 100:1 to about 2:1-including all values and sub-ranges thereof. The depth of the slots 624 may range from about 1 mm to about 30 mm—including all values and sub-ranges thereof. A width of the slots 624, which may be defined by a distance between opposing sidewalls of the slots 624 may range from about 1 mm to about 20 mm—including all values and sub-ranges thereof. In some embodiments, the slots 624 formed in the building panel 600 may be of the same length, width, and/or depth. In some embodiments, slots 624 of varying lengths, widths, and/or depths may be formed.

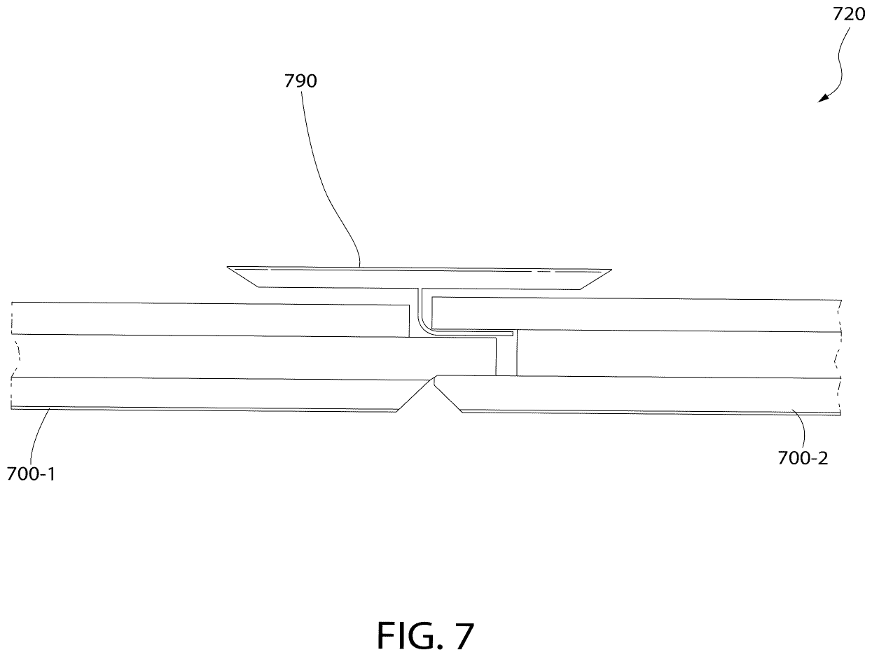

FIG. 7 schematically illustrates a portion of a building panel system 720 including one or more building panels 700 according to some embodiments of the present invention. The panel system 720 may include a first building panel 700-1, a second building panel 700-2 coupled or mated to the first building panel 700-1, and at least one mounting member 790 for coupling or attaching the first and second panels 700-1, 700-2 to a ceiling and/or a wall via a support structure, such as a ceiling/wall mounting grid. The building panel 700 may be similar to the building panel 100, 300, 400, 500, 600 describe above. Similar numbering scheme will be used for the building panel 700 as with building panel 100, 300, 400, 500, 600 except that the 700-series of numbers will be used.

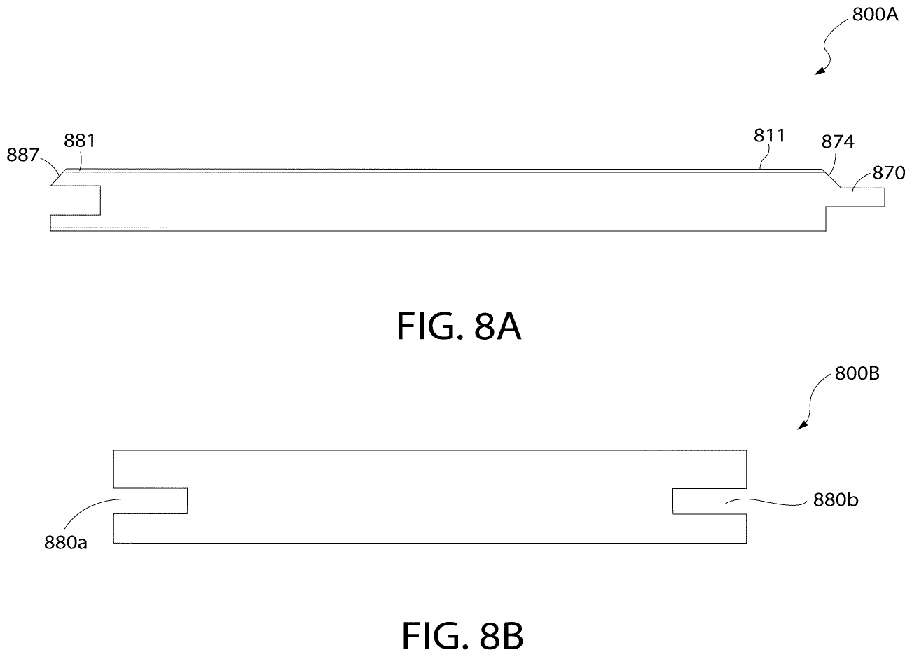

FIGS. 8A and 8B schematically illustrate additional building panels 800 according to some embodiments of the present invention. The building panel 800 may be similar to the building panel 100, 300, 400, 500, 600, 700 describe above. Similar numbering scheme will be used for the building panel 800 as with building panel 100, 300, 400, 500, 600, 700 except that the 800-series of numbers will be used.

With reference to FIG. 8A, the building panel 800A may differ from the building panel 300 in that the entire side surface 887 of the first overhang 881 of the building panel 800A may be sloped. The side surface 887 of the first overhang 881 of a first building panel 800A-1 and the side surface 874 between the tongue 870 and the first major surface 811 of a second, adjacent building panel 800A-1 may define a “V” groove between the two panels 800A.

With reference to FIG. 8B, in some embodiments, instead of a tongue-and-groove mating mechanism along the edge portions of the building panel, the building panel 800B may include grooves 880a, 880b formed along opposite edge portions of the building panel 800B. Each of the grooves 880 may be configured to receive therein a portion of a mounting member or a support structure such that the building panel 800B may be mounted and/or secured to the support structure and form coverage for a wall and/or a ceiling along with one or more other building panels.

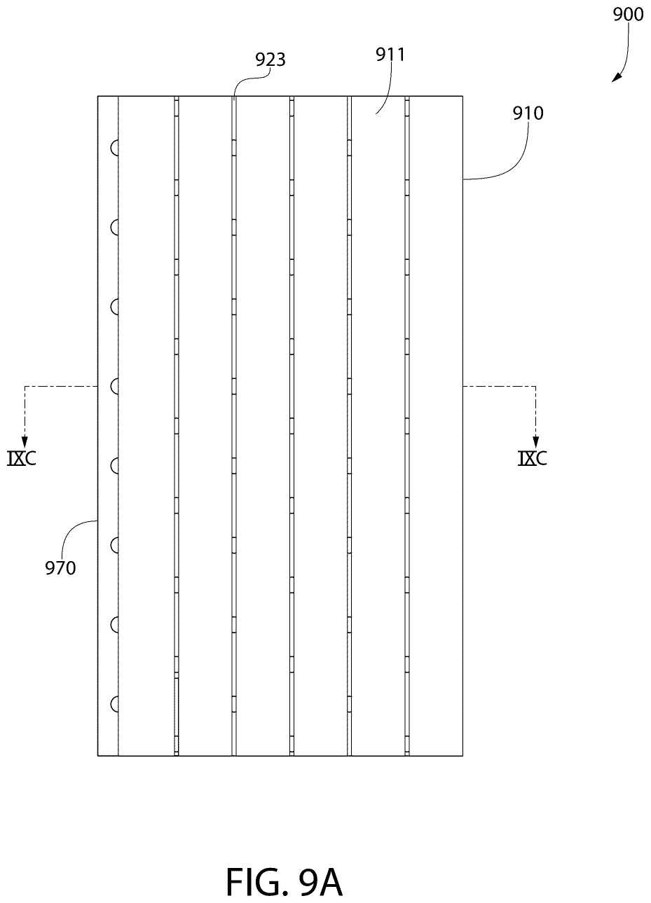

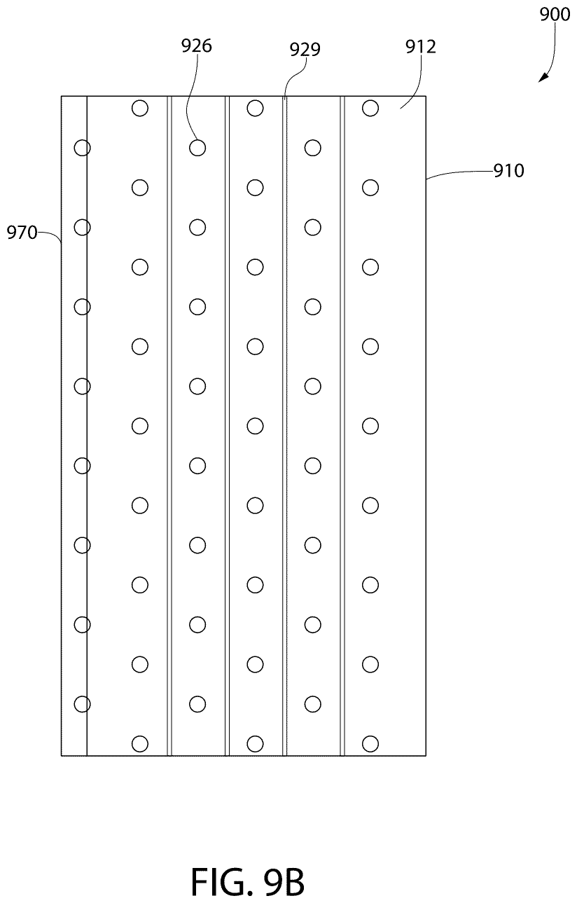

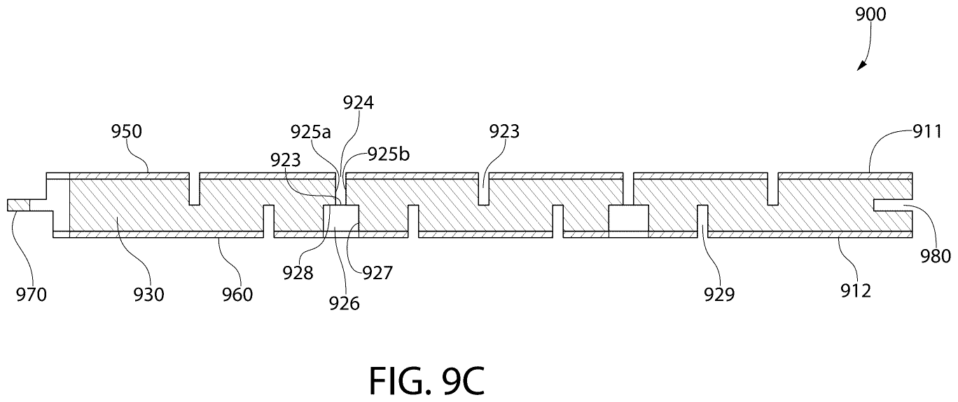

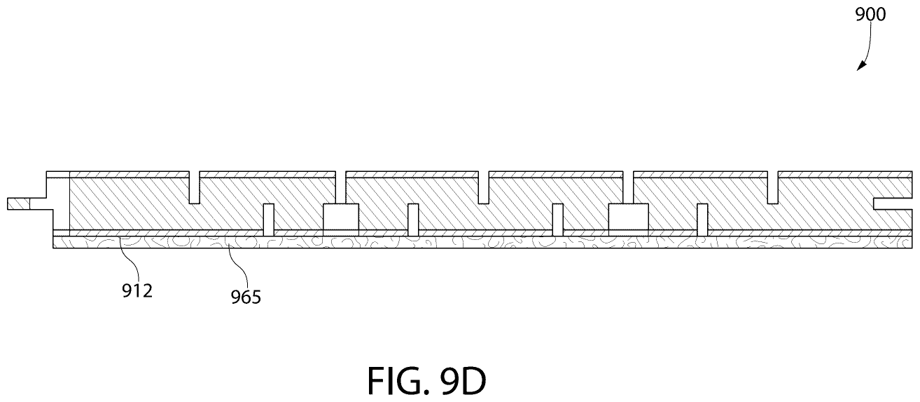

FIGS. 9A-9D schematically illustrate an additional building panel 900 according to some embodiments of the present invention. FIG. 9A schematically illustrates a front view of the building panel 900. FIG. 9B schematically illustrates a back view of the building panel 900. FIG. 9C schematically illustrates a cross-sectional view of the building panel 900, taken along line IXC-IXC in FIG. 9A. FIG. 9D schematically illustrates a cross-sectional view of the building panel 900 having an acoustical layer 965 attached to the building panel 900. The building panel 900 may be similar to the building panel 100, 300, 400, 500, 600, 700, 800 describe above. Similar numbering scheme will be used for the building panel 900 as with building panel 100, 300, 400, 500, 600, 700, 800 except that the 900-series of numbers will be used.

With reference to FIGS. 9A-9C, the building panel 900 may include a body 910 having a first major surface 911 and a second major surface 912 opposite the first major surface 911. The body 910 may further include a first facing 950 defining the first major surface 911, a second facing 960 defining the second major surface 912, and a core 930 between the first facing 950 and the second facing 960. In some embodiments, the body 910 may not include the first facing 950 and/or the second facing 960. In some embodiments, the first major surface 911 and/or the second major surface 912 may comprise opposite major surfaces of the core 930.

In some embodiments, the body 910 may further include a reinforcement member (not shown) disposed in the core 930. In some embodiments, the body 910 may further include a tongue 970 and a groove 980. In some embodiments, a height of the groove 980 may be greater than a height of the tongue 970. When two or more building panels 900 are assembled together, gaps may be formed between adjacent building panels 900 to accommodate mounting members for attaching the building panels 900 to a support structure to form coverage for a wall and/or ceiling.

With further reference to FIGS. 9A and 9C, in some embodiments, one or more slots 923 may be formed in the first major surface 911. The provision of the slots 923 in the building panel 900 may at least in part reduce the overall weight of the building panel 900. In some embodiments, the slots 923 may extend from an edge of the first major surface 911 to an opposite edge of the first major surface 911, and the slots 923 may extend along the entire width or length of the first major surface 911. In some embodiments, the slots 923 may extend along a portion or portions of the width or length of the first major surface 911, and thus may not extend to the edge(s) of the first major surface 911. Although FIG. 9A illustrates that the slots 923 may be oriented or extend parallel to the length dimension of the building panel 900 in some embodiments, the slots 923 may be oriented parallel to the width dimension or in any suitable orientation.

With further reference to FIGS. 9A and 9C, the slots 923 may extend from the first major surface 911 towards the second major surface 912. A depth of the slots 923 may be defined by a distance between a bottom end 924 of each slot 923 and the first major surface 911. In some embodiments, the depth of the slots 923 may be less than the thickness of the body 910 as defined by the distance between the first major surface 911 and the second major surface 912. In some embodiments, a ratio of the depth of the slots 923 to the thickness of the body 910 may range from about 1:100 to about 1:2. In some embodiments, the depth of the slots 923 may range from about 1 mm to about 30 mm-including all values and sub-ranges thereof. A width of the slots 923 may be defined by opposite sidewalls 925a, 925b. The width of the slots 923 may range from about 1 mm to about 20 mm-including all values and sub-ranges thereof.

In some embodiments, one or more perforations 926 may be formed in the second major surface 912 and may extend from the second major surface 912 towards the first major surface 911. The provision of the perforations 926 in the building panel 900 may at least in part reduce the overall weight of the building panel 900. In some embodiments, at least some of the perforations 926 may align with one or more of the slots 923 such that the perforations 926 may extend from the second major surface 912 to the bottom ends 924 of the slots 923 and air flow passageways may be formed between the first major surface 911 and the second major surface 912 through the slots 923 and the perforations 926. Such air passageways may improve the acoustical performance of the building panel 900.

A width or diameter of the perforations 926 may be defined by the diameter of the cylindrical sidewall 927 of the perforations 926. In some embodiments, the width or diameter of the perforations 926 may be greater than the width of the slots 923. Such difference in the widths of the slots 923 and the perforations 926 may allow for improvement in acoustical performance and weight reduction of the building panel 900 without sacrificing the aesthetics of the building panel 900 because the perforations 926 may be less visible from the first major surface 911. In some embodiments, the diameter or width of the perforations 926 may range from about 0.5 mm to about 100 mm—including all values and sub-ranges thereof. For example, in some embodiments, the perforations 926 may have a diameter ranging from, e.g., about 0.5 mm to about 50 mm, about 0.5 mm to about 40 mm, about 0.5 mm to about 30 mm, about 0.5 mm to about 20 mm, about 0.5 mm to about 10 mm, about 0.5 mm to about 8 mm, about 0.5 mm to about 6 mm, about 0.5 mm to about 4 mm, about 0.5 mm to about 2 mm, or about 0.5 mm to about 1 mm, to achieve desired acoustical performance and/or any other desired properties. In some embodiments, the perforations 926 may have a uniform size (e.g., diameter). In some embodiments, the perforations 926 may have non-uniform, varied sizes. In some embodiments, a ratio of the width or diameter of the perforations 926 to the width of the slots 923 may range from about 0.05:1 to about 100:1—including all values and sub-ranges thereof.

A depth of the perforations 926 may be defined by a distance between a bottom end 928 of each perforation 926 and the second major surface 912. In some embodiments, the depth of the perforations 926 may be less than the thickness of the body 910. The depth of the perforations 926 may range from about 1 mm to about 50 mm—including all values and sub-ranges thereof. A ratio of the depth of the perforations 926 to the thickness of the body 910 may range from about 5% to about 100%—including all values and sub-ranges thereof.

Although perforations 926 shown in FIGS. 9A-9C have a circular cross section, the perforations 926 may have oval, polygonal, or any suitable cross sectional shapes. Further, in some embodiments, the perforations 926 may have a consistent width and/or depth, while in some embodiments, the building panel 900 may include perforations 926 having different widths and/or depths formed therein. In some embodiments, some of the perforations 926 may be formed as through holes extending from the second major surface 912 to the first major surface 911.

With reference to FIGS. 9B and 9C, in some embodiments, the building panel 900 may further include one or more slots 929 formed in the second major surface 912 and extend from the second major surface 912 towards the first major surface 911. The slots 929 formed in the second major surface 912 may be similar to the slots 923 formed in the first major surface 911. A depth of the slots 929 may be defined by a distance between a bottom end of each slot 929 to the second major surface 912. The depth of the slots 929 formed in the second major surface 912 may be less than the thickness of the body. In some embodiments, a ratio of the depth of the slots 929 to the thickness of the body 910 may range from about 1:100 to about 1:2. In some embodiments, the depth of the slots 929 may range from about 1 mm to about 30 mm—including all values and sub-ranges thereof. A width of the slots 929 may be defined by a distance between opposite sidewalls of each slot 929. The width of the slots 929 may range from about 1 mm to about 20 mm—including all values and sub-ranges thereof. In some embodiments, the slots 929 formed in the second major surface 912 may be vertically offset from the slots 923 formed in the first major surface 911. In some embodiments, the slots 929 formed in the second major surface 912 may be vertically aligned with the slots 923 formed in the first major surface 911, but may not be in fluid communication with the slots 923 formed in the first major surface 911.

Similar to the other building panels described herein, the core 930 of the body 910 of the building panel 900 may include or may be formed from the composite including MgO and MgSO₄ as described above. Depending on the size and/or number of the slots 923 formed in the first major surface 911, the slots 929 formed in the second major surface 912, and/or the perforations 926 formed in the second major surface 912, from about 65% to about 99%—including all values and sub-ranges thereof—of the volume of the body 910 may be occupied by the composite. For example, in some embodiments, from about 65% to about 95%, from about 65% to about 85%, from about 65% to about 75%, from about 75% to about 95%, from about 75% to about 85%, or from about 85% to about 95% of the volume of the body 910 may be occupied by the composite.

In some embodiments, the building panel 900 may further include an acoustical layer 965 coupled to the second major surface 912 of the body 910. In some embodiments, the acoustical layer 965 may include a fleece layer, a fiberglass scrim, a fabric, a mesh, or any other suitable porous and/or acoustical materials. The acoustical layer 965 may be attached to the second major surface 912 of the body 910 using an adhesive or any other suitable fasting mechanism.

Depending on the size and/or number of the slots 923, 929, the size and/or number of the perforations 926, and/or the acoustical layer 965 employed, any suitable or desired air flow resistance of the building panel 900 as measured between the first major surface 911 and the second major surface 912 may be achieved. In some embodiments, the building panel 900 may have an air flow resistance ranging from about 0.1 to infinity—including all values and sub-ranges thereof. The building panel 900 may exhibit an NRC of at least about 0.30 as measured between the first major surface 911 and the second major surface 912. In some embodiments, the building panel 900 has an NRC ranging from about 0.30 to about 0.95—including all values and sub-ranges there-between.

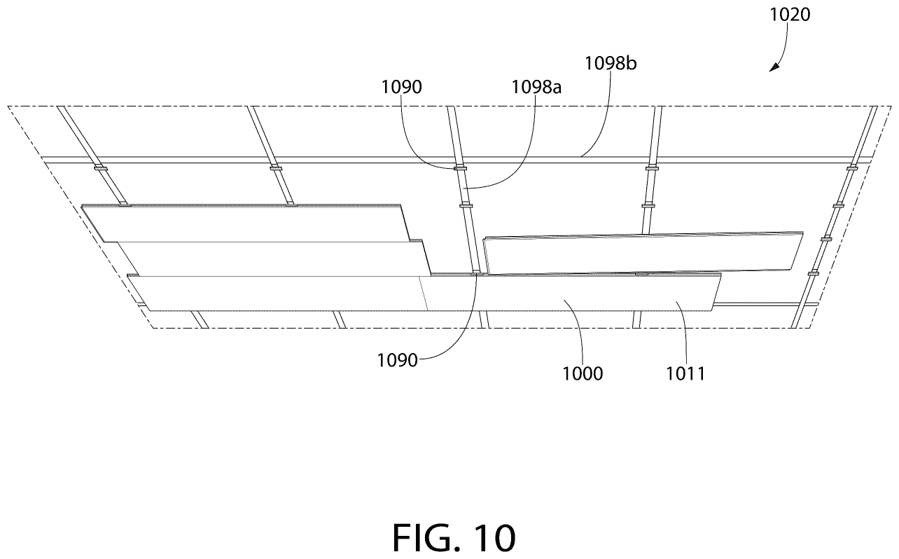

FIG. 10 schematically illustrates a portion of a building panel system 1020, such as a ceiling system, according to some embodiments of the present invention. The panel system 1020 may include one or more building panels 1000, some of which are in the installed state. The building panel 1000 may be the same as or similar to any of the building panels 100, 300, 400, 500, 600, 700, 800, 900 described above. The panel system 1020 may be installed in an interior space. The interior space may include a plenary space above the building panels 1000 and an active room environment below the building panels 1000. The plenary space may provide space for mechanical lines within a building (e.g., HVAC, plumbing, etc.). The active space may provide room for the building occupants during normal intended use of the building (e.g., in an office building, the active space would be occupied by offices containing computers, lamps, etc.).

It should be noted that although FIG. 10 illustrates an embodiment where the building panels are installed for an indoor/interior application, the application of the building panels are not limited to indoor/interior use only. The various building panels described here may also be suitable for outdoor/exterior applications, such as forming exterior coverage for a portion or an entirety of a wall, roof, and/or ceiling of a building.

In the installed state, the first major surface 1011 of the building panel 1000 may face the active room environment and the second major surface of the building panel 1000 may face the plenary space. The building panels 1000 may be supported in the interior space by a support structure which may include a support grid. The support grid may include one or more first struts 1098a that are substantially parallel to each other and one or more second struts 1098b that are substantially perpendicular to the first struts 1098a. In some embodiments, the one or more second struts 1098b may intersect the one or more first struts 1098a to create an intersecting ceiling support grid. The plenary space exists above the ceiling support grid, and the active room environment exists below the ceiling support grid.

In some embodiments, one or more of the first support struts 1098a may include one or more mounting members 1090 coupled thereto. The mounting member 1090 may be configured to slide or move along the first support strut 1098a after the mounting member 1090 has been coupled to the first support strut 1098a.

To install a building panel 1000 to the support structure, the building panel 1000 may be brought up to the support structure. The building panel 1000 may be oriented such that an edge portion along which a groove of the building panel 1000 may be formed is perpendicular to the first strut 1098a. A mounting member 1090 may then be moved along the first support strut 1098a toward the building panel 1000 until a mounting flange of the mounting member 1090 is received in the groove of the building panel 1000. The overhang at least in part forming the groove may then rest upon the mounting flange of the mounting member 1090, and the building panel 1000 may then be supported at least in part by the mounting member 1090 off of the support structure.

When the building panel 1000 is brought up to the support structure for installation, the building panel 1000 may also be brought in proximity to a building panel 1000 that has been installed previously such that the tongue of the building panel 1000 to be installed, as well as the mounting flange of the mounting member 1090 supporting the building panel 1000 previously installed, may be received together in the groove of the building panel 1000 previously installed. A web of the mounting member 1090 supporting the building panel 1000 installed previously may be disposed between side surfaces of the building panel 1000 installed previously and the building panel 1000 to be installed.

In some embodiments, alternative or in addition to using mounting members described above, the building panels may be secured to a wall and/or ceiling using an adhesive component, such as the adhesive components described in U.S. patent application Ser. No. 16/290,892, filed on Mar. 2, 2019, and U.S. patent application Ser. No. 17/963,571, filed on Oct. 11, 2022, the entireties of which are incorporated herein by reference. When using an adhesive component, the building panels may be secured to the wall and/or ceiling with or without additional support structure.

In some embodiments, the building panel described herein may be manufactured according to the following methodology. A mixture may be formed by combining MgO, MgSO₄, and a liquid carrier. The liquid carrier may include water. MgO and/or MgSO₄ may be in an anhydrous state before combining with the liquid carrier. In some embodiments, perlite may be included in the mixture. In some embodiments, a fibrous component may be included in the mixture. The fibrous composite may include a natural and/or synthetic fibrous component. In some embodiments, the fibrous component may include a cellulosic fiber, such as a wood fiber (e.g., wood chips), a bamboo fiber, and/or other natural fiber. In some embodiments, a dry, powder blend may be formed before the addition of the liquid carrier, whereby the dry blend may include MgO powder and MgSO₄ powder. In some embodiments, the dry blend may further include perlite and/or a fibrous component. The dry blend may then be combined with a liquid carrier, such as water, and agitated to create a uniformly mixed, flowable mixture.

The mixture may then be processed into a uniform web. In some embodiments, the uniform web may be formed by flowing the mixture onto a layer of material forming the reinforcement member. The mixture may penetrate the material layer and cover both sides of the material layer forming the reinforcement member. The web may then be subjected to a drying process and cut into sheets of desired sizes. The cut sheets may then be cured in an oven to form the core of the building panel. During the drying and/or curing stage, the temperature for drying web and/or curing the cut sheets may be gradually increased.

In some embodiments, the temperature for drying and/or curing may be increased through multiple stages. Such staged drying and/or curing may reduce the internal stress inside the core and/or the building panel formed. Staged drying and/or curing may also allow for better control over the final moisture content in the core and/or the building panel formed. Reduced internal stress and/or improved control over the final moisture content may in turn minimize warpage, chipping and/or cracking of the core and/or the building panel produced and/or reduce delamination of the facing layers that may be subsequently applied.

In some embodiments, alternative to the web-laid process described above, the mixture may be flowed into a mold to fill the mold at least partially. In some embodiments, a reinforcement member may be disposed over the mixture in the at least partially filled mold. In some embodiments, an additional amount of the mixture may be flowed into the mold over the reinforcement member. Once in the mold, the mixture may react or harden such that a composite of MgO and MgSO₄ may be formed, and the reinforcement member, if included, may bind to the composite. The composite and/or the reinforcement member may then be removed from the mold. In some embodiments, the mold may be formed of a deformable material that may not adhere to the composite. In a non-limiting embodiment, the mold may be formed of a silicone.

The mold may have a geometry that conforms to the dimensions of the core of a building panel. The composite and the reinforcement member, if included, may form the core of the building panel. In some embodiments, the geometry of the mold may further conform to the tongue and/or the groove of the building panel. The term “geometry that conforms” refers to a geometry capable of producing the corresponding geometry of the resulting core, tongue, and/or groove. For instance, a geometry conforming to the dimensions of the core, tongue, and/or groove will be a mold having a negative space capable of being filled with the flowable mixture, whereby the negative space of the mold results in the core, tongue, and/or groove having the aforementioned shapes and/or sizes. In some embodiments, the mold may be configured to produce a preform of the core having select dimensions greater than the core, and the tongue and/or groove may be subsequently machined into the preform to form the core.

Once the core is formed, in some embodiments, a facing, such as a first facing as described herein, may be applied to a first major surface of the core. In some embodiments, another facing, such as a second facing as described herein, may be applied to a second major surface of the core opposite the first major surface. In some embodiments, the first and/or second facings may include a preformed layer. Such preformed layer may be attached or coupled to the major surface(s) of the core using any suitable fastening mechanism, such as an adhesive, tape, staples, nails, screws, clips, hook and loop fasteners, and so on. In some embodiments, the first facing and/or the second facing may include a coating formed by applying a coating material or composition to the major surface(s) of the core. The core and the facing(s) may collectively form the body of the building panel. In some embodiments, the facing(s) may be applied to the core prior to forming the tongue and/or groove of the building panel. In some embodiments, the facing(s) may be applied to the core subsequent to forming the tongue and/or groove of the building panel.

### Exemplary Claim Set

Exemplary claim 1. A building panel, comprising a body, the body comprising: a core, the core comprising: a first major surface; a second major surface opposite the first major surface; a thickness defined by a distance between the first major surface and the second major surface; and a volume defined at least in part by the first major surface and the second major surface; wherein: at least 95% of the volume of the core is occupied by a composite comprising MgO and MgSO₄; and the thickness of the core is greater than 85% of a thickness of the body.

Exemplary claim 2. The building panel according to Exemplary claim 1, wherein: the body comprises a first major surface, and a second major surface opposite the first major surface; the thickness of the body is defined by a distance between the first major surface of the body and the second major surface of the body; the first major surface of the body defines an exterior or exposed surface of the building panel; and the second major surface of the body defines an exterior or exposed surface of the building panel.

Exemplary claim 3. The building panel according to any one of Exemplary claims 1 to 2, wherein a density of the composite is substantially uniform within the at least 95% of the volume of the core occupied by the composite.

Exemplary claim 4. The building panel according to any one of Exemplary claims 1 to 3, wherein: an entirety of the first major surface of the core is substantially planar and/or continuous; and an entirety of the second major surface of the core is substantially planar and/or continuous.

Exemplary claim 5. The building panel according to any one of Exemplary claims 1 to 4, wherein a density of the core ranges from about 0.6 g/cm³ to about 1.8 g/cm³, 0.8 g/cm³ to about 1.6 g/cm³, from about 1.1 g/cm³ to about 1.4 g/cm³, or from about 1 g/cm³ to about 1.4g/cm^{3 .}

Exemplary claim 6. The building panel according to any one of Exemplary claims 1 to 4, wherein a density of the core is less than 1.1 g/cm³ or less than 1 g/cm³.

Exemplary claim 7. The building panel according to any one of Exemplary claims 1 to 4, wherein a density of the core ranges from about 0.6 g/cm³ to about 1 g/cm³ or from about 0.8 g/cm³ to about 1g/cm³.

Exemplary claim 8. The building panel according to any one of Exemplary claims 1 to 4, wherein a density of the composite ranges from about 0.6 g/cm³ to about 1.8 g/cm³, 0.8 g/cm³ to about 1.6 g/cm³, from about 1.1 g/cm³ to about 1.4 g/cm³, or from about 1 g/cm³ to about 1.4 g/cm³.

Exemplary claim 9. The building panel according to any one of Exemplary claims 1 to 4, wherein a density of the composite is less than 1.1 g/cm³ or less than 1 g/cm³.

Exemplary claim 10. The building panel according to any one of Exemplary claims 1 to 4, wherein a density of the composite ranges from about 0.6 g/cm³ to about 1 g/cm³ or from about 0.8 g/cm³ to about 1 g/cm³.

Exemplary claim 11. The building panel according to any one of Exemplary claims 1 to 10, wherein the composite comprises, based on a weight of the composite: 50 wt. % to 87 wt. % of MgO; and 15 wt. % to 45 wt. % of MgSO₄.

Exemplary claim 12. The building panel according to any one of Exemplary claims 1 to 11, wherein the composite comprises, based on the weight of the composite: 1 wt. % to 15 wt. % of perlite; and 1 wt. % to 20 wt. % of a cellulosic fiber.

Exemplary claim 13. The building panel according to any one of Exemplary claims 1 to 12, wherein the composite comprises: no greater than 1% of oxide other than MgO; no greater than 1% of chloride ions; and no greater than 1% of sodium ions.

Exemplary claim 14. The building panel according to any one of Exemplary claims 1 to 13, wherein the core is substantially free of MgCl₂.

Exemplary claim 15. The building panel according to any one of Exemplary claims 1 to 14, wherein the core further comprises a reinforcement member disposed between the first major surface of the core and the second major surface of the core.

Exemplary claim 16. The building panel according to Exemplary claim 15, wherein the reinforce member comprises at least one of a fiberglass mesh, felt mesh, metal wire mesh, or fabric mesh.

Exemplary claim 17. The building panel according to any one of Exemplary claims 15 to 16, wherein a thickness of the reinforcement member ranges from about 0.5 mil to about 50 mil.

Exemplary claim 18. The building panel according to any one of Exemplary claims 15 to 17, wherein a thickness of the reinforcement member ranges from about 0.02% to about 64% of the thickness of the core.

Exemplary claim 19. The building panel according to any one of Exemplary claims 15 to 18, wherein a length of the reinforcement member substantially corresponds to at least one of a length of the first major surface of the core or a length of the second major surface of the core.

Exemplary claim 20. The building panel according to any one of Exemplary claims 15 to 19, wherein a width of the reinforcement member substantially corresponds to at least one of a width of the first major surface of the core or a width of the second major surface of the core.

Exemplary claim 21. The building panel according to any one of Exemplary claims 1 to 20, wherein: the core further comprises a side surface extending between the first major surface and the second major surface; and the side surface is substantially planar.

Exemplary claim 22. The building panel according to any one of Exemplary claims 1 to 20, wherein the body further comprises: a first groove formed along a first edge portion of the body; and a second groove formed along a second edge portion of the body opposite the first edge portion of the body.

Exemplary claim 23. The building panel according to any one of Exemplary claims 1 to 20, wherein the body further comprises: a tongue formed along a first edge portion of the body; and a groove formed along a second edge portion of the body opposite the first edge portion of the body.

Exemplary claim 24. The building panel according to Exemplary claim 23, wherein at least one of the tongue or the groove is defined by the core.

Exemplary claim 25. The building panel according to any one of Exemplary claims 23 to 24, wherein a height of the groove is greater than a height of the tongue.

Exemplary claim 26. The building panel according to any one of Exemplary claims 23 to 25, wherein the groove is configured to receive therein a tongue of another building panel and a portion of a mounting member.

Exemplary claim 27. The building panel according to Exemplary claim 23, wherein: the core comprises a first overhang and a second overhang; the first overhang and the second overhang define at least in part the groove; the first overhang comprises an outer surface forming a portion of a first major surface of the body and an inner surface opposite the outer surface of the first overhang; the second overhang comprises an outer surface forming a portion of a second major surface of the body and an inner surface opposite the outer surface of the second overhang; a height of the groove is defined by a distance between the inner surface of the first overhang and the inner surface of the second overhang; the tongue comprises a first surface and a second surface opposite the first surface of the tongue; and a height of the tongue is defined by a distance between the first surface of the tongue and the second surface of the tongue.

Exemplary claim 28. The building panel according to Exemplary claim 27, wherein the height of the groove is greater than the height of the tongue.

Exemplary claim 29. The building panel according to any one of Exemplary claims 27 to 28, wherein the height of the tongue ranges from 1.3 mm to 25 mm.

Exemplary claim 30. The building panel according to any one of Exemplary claims 27to 29, wherein the height of the groove ranges from 1.5 mm to 30 mm.

Exemplary claim 31. The building panel according to any one of Exemplary claims 27 to 30, wherein a ratio of the thickness of the core to the height of the tongue ranges from 38:1 to 1.2:1.

Exemplary claim 32. The building panel according to any one of Exemplary claims 27 to 31, wherein a ratio of the thickness of the core to the height of the groove ranges from 38:1 to 1.1:1.

Exemplary claim 33. The building panel according to any one of Exemplary claims 27 to 32, wherein the height of the groove is greater than the height of the tongue by about 2% to about 100% of the height of the tongue.

Exemplary claim 34. The building panel according to any one of Exemplary claims 27 to 33, wherein a difference between the height of the groove and the height of the tongue ranges from about 0.1 mm to about 15 mm.

Exemplary claim 35. The building panel according to any one of Exemplary claims 27 to 34, wherein a difference between the height of the groove and the height of the tongue is about 0.5 mm.

Exemplary claim 36. The building panel according to any one of Exemplary claims 27 to 35, wherein the first surface of the tongue is offset from the first major surface of the core by a vertical distance that substantially corresponds to a vertical distance between the first major surface of the core and the inner surface of the first overhang.

Exemplary claim 37. The building panel according to any one of Exemplary claims 27 to 36, wherein the second surface of the tongue is offset from the second major surface of the core by a vertical distance that is greater than a vertical distance between the second major surface of the core and the inner surface of the second overhang.

Exemplary claim 38. The building panel according to any one of Exemplary claims 27 to 36, wherein the second surface of the tongue is offset from the second major surface of the core by a vertical distance that substantially corresponds to a vertical distance between the second major surface of the core and the inner surface of the second overhang.

Exemplary claim 39. The building panel according to any one of Exemplary claims 27 to 35, wherein the first surface of the tongue is offset from the first major surface of the core by a vertical distance that is greater than a vertical distance between the first major surface of the core and the inner surface of the first overhang.

Exemplary claim 40. The building panel according to any one of Exemplary claims 27 to 39, wherein the first overhang comprises a side surface between the outer surface and the inner surface of the first overhang.

Exemplary claim 41. The building panel according to Exemplary claim 40, wherein the side surface of the first overhang is sloped relative to the outer surface of the first overhang.

Exemplary claim 42. The building panel according to any one of Exemplary claims 40 to 41, wherein the side surface of the first overhang is sloped relative to the outer surface of the first overhang at an angle ranging from about 20 degrees to 90 degrees.

Exemplary claim 43. The building panel according to Exemplary claim 40, wherein the side surface of the first overhang is substantially perpendicular to the outer surface of the first overhang.

Exemplary claim 44. The building panel according to Exemplary claim 40, wherein a corner defined by the side surface of the first overhang and the outer surface of the first overhang is beveled or chamfered such that a sloped edge is formed between the side surface of the first overhang and the outer surface of the first overhang.

Exemplary claim 45. The building panel according to Exemplary claim 44, wherein the sloped edge is sloped relative to the side surface of the first overhang at an angle ranging from about 0 degree to about 70 degrees.

Exemplary claim 46. The building panel according to Exemplary claim 40, wherein: the second overhang comprises a side surface extending between the outer surface and the inner surface of the second overhang; and the side surface of the first overhang and the side surface of the second overhang are substantially coplanar or aligned vertically.

Exemplary claim 47. The building panel according to any one of Exemplary claims 27 to 46, wherein the core further comprises: a first side surface extending between the first surface of the tongue and the first major surface of the core; and a second side surface extending between the second surface of the tongue and the second major surface of the core.

Exemplary claim 48. The building panel according to Exemplary claim 47, wherein the first side surface of the core is sloped relative to the first major surface of the core.

Exemplary claim 49. The building panel according to any one of Exemplary claims 47 to 48, wherein the first side surface of the core is sloped relative to the first major surface of the core at an angle ranging from about 20 degrees to 90 degrees.

Exemplary claim 50. The building panel according to Exemplary claim 47, wherein the first side surface of the core is substantially perpendicular to the first major surface of the core.

Exemplary claim 51. The building panel according to Exemplary claim 47, wherein a corner defined by the first side surface of the core and the first major surface of the core is beveled or chamfered such that a sloped edge is formed between the first side surface of the core and the first major surface of the core.

Exemplary claim 52. The building panel according to Exemplary claim 51, wherein the sloped edge is sloped relative to the first major surface of the core at an angle ranging from about 20 degrees to 90 degrees.

Exemplary claim 53. The building panel according to Exemplary claim 47, wherein the first side surface of the core and the second side surface of the core are substantially coplanar or aligned vertically.

Exemplary claim 54. The building panel according to any one of Exemplary claims 47 to 53, wherein the tongue comprises a side surface defining a terminal end of the tongue.

Exemplary claim 55. The building panel according to Exemplary claim 55, wherein: a width of the first surface of the tongue extends between the first side surface of the core and the side surface of the tongue; and a width of the second surface of the tongue extending between the second side surface of the core and the side surface of the tongue.

Exemplary claim 56. The building panel according to Exemplary claim 55, wherein the width of the first surface of the tongue is different from the width of the second surface of the tongue.

Exemplary claim 57. The building panel according to any one of Exemplary claims 55 to 56, wherein the width of the first surface of the tongue is less than the width of the second surface of the tongue.

Exemplary claim 58. The building panel according to any one of Exemplary claims 55 to 57, wherein a difference between the width of the first surface of the tongue and the width of the second surface of the tongue ranges from about 1 mm to about 20 mm.

Exemplary claim 59. The building panel according to any one of Exemplary claims 55 to 58, wherein a width of the tongue is defined by the lesser of the width of the first surface of the tongue or the width of the second surface of the tongue.

Exemplary claim 60. The building panel according to Exemplary claim 59, wherein a ratio of the width of the tongue to the height of the tongue ranges from 0.05:1 to 20:1.

Exemplary claim 61. The building panel according to any one of Exemplary claims 59 to 60, wherein a ratio of the width of the tongue to the thickness of the core ranges from 20:1 to 1:1.

Exemplary claim 62. The building panel according to any one of Exemplary claims 59 to 61, wherein the width of the tongue ranges from about 3 mm to about 25 mm.

Exemplary claim 63. The building panel according to any one of Exemplary claims 27 to 62, wherein: the first surface of the tongue is substantially planar; the second surface of the tongue is substantially planar; the inner surface of the first overhang is substantially planar; and the inner surface of the second overhang is substantially planar.

Exemplary claim 64. The building panel according to any one of Exemplary claims 1 to 63, wherein the body further comprises at least one of: a first facing over at least a portion of the first major surface of the core; or a second facing over at least a portion of the second major surface of the core.

Exemplary claim 65. The building panel according to Exemplary claim 64, wherein at least one of the first facing or the second facing comprises one or more layers of a melamine-based material, a low pressure laminate (LPL), a high pressure laminate (HPL), a scrim, a film, a coating, an ink layer, a veneer, or paper.

Exemplary claim 66. The building panel according to any one of Exemplary claims 64 to 65, wherein at least one of the first facing or the second facing comprises a single-layer structure.

Exemplary claim 67. The building panel according to any one of Exemplary claims 64 to 65, wherein at least one of the first facing or the second facing comprises a multi-layer structure.

Exemplary claim 68. The building panel according to any one of Exemplary claims 64 to 67, wherein the first facing overlays an entirety of the first major surface of the core.

Exemplary claim 69. The building panel according to any one of Exemplary claims 64 to 68, wherein the second facing overlays an entirety of the second major surface of the core.

Exemplary claim 70. The building panel according to any one of Exemplary claims 64 to 69, wherein a thickness of the first facing ranging from about 1 mil to about 40 mils.

Exemplary claim 71. The building panel according to any one of Exemplary claims 64 to 70, wherein a thickness of the second facing ranging from about 1 mil to about 40 mils.

Exemplary claim 72. The building panel according to any one of Exemplary claims 64 to 71, wherein at least one of the first facing, the second facing, or the core comprises a plurality of perforations.

Exemplary claim 73. The building panel according to Exemplary claim 72, wherein an average diameter of the plurality of perforations ranges from about 50 mils to 4 inches.

Exemplary claim 74. The building panel according to any one of Exemplary claims 72 to 73, wherein an average diameter of the plurality of perforations ranges from about 50 mils to 2 inches.

Exemplary claim 75. The building panel according to any one of Exemplary claims 72 to 74, wherein a density of the plurality of perforations ranges from about 1 perforation per ft² to about 100 perforations per ft².

Exemplary claim 76. The building panel according to any one of Exemplary claims 1 to 75, wherein the thickness of the core ranges from about 2 mm to about 50 mm.

Exemplary claim 77. The building panel according to any one of Exemplary claims 1 to 76, wherein: a length of the body ranges from about 1 ft to 12 ft; and a width of the body ranges from about 0.25 ft to 4.4 ft.

Exemplary claim 78. The building panel according to any one of Exemplary claims 1 to 77, wherein a warpage of the body is less than 20 mm as measured by center gravity sag.

Exemplary claim 79. The building panel according to any one of Exemplary claims 1 to 78, wherein the building panel comprises a ceiling panel.

Exemplary claim 80. A building panel, comprising a body, the body comprising: a core, the core comprising: a composite comprising MgO and MgSO₄; a first major surface; and a second major surface opposite the first major surface; and a first facing over at least a portion of the first major surface of the core; a second facing over at least a portion of the second major surface of the core; and wherein: a thickness of the core is defined by a distance between the first major surface and the second major surface; a thickness of the body is defined by a distance between an exterior surface of the first facing and an exterior surface of the second facing; the thickness of the core is greater than 85% of the thickness of the body; and a density of the composite is substantially uniform across the entire thickness of the core.

Exemplary claim 81. The building panel according to Exemplary claim 80, wherein a density of the core ranges from about 0.6 g/cm³ to about 1.8 g/cm³.

Exemplary claim 82. The building panel according to any one of Exemplary claims 80 to 81, wherein a density of the core is less than 1 g/cm³.

Exemplary claim 83. The building panel according to any one of Exemplary claims 80 to 82, wherein the composite comprises: 50 wt. % to 87 wt. % of MgO; and 15 wt. % to 45 wt. % of MgSO₄.

Exemplary claim 84. The building panel according to any one of Exemplary claims 80 to 83, wherein the composite comprises more than 55 wt. % of MgO.

Exemplary claim 85. The building panel according to any one of Exemplary claims 80 to 84, wherein the composite further comprises: 1 wt. % to 15 wt. % of perlite; and 1 wt. % to 20 wt. % of a cellulosic fiber.

Exemplary claim 86. The building panel according to any one of Exemplary claims 80 to 85, wherein the composite further comprises: no greater than 1% of oxide other than MgO; no greater than 1% of chloride ions; and no greater than 1% of sodium ions.

Exemplary claim 87. The building panel according to any one of Exemplary claims 80 to 86, wherein the composite is substantially free of MgCl₂.

Exemplary claim 88. The building panel according to any one of Exemplary claims 80 to 87, wherein at least one of the first facing or the second facing comprises one or more layers of a melamine-based material, a low pressure laminate (LPL), a high pressure laminate (HPL), a scrim, a film, a coating, an ink layer, a veneer, or paper.

Exemplary claim 89. The building panel according to any one of Exemplary claims 80 to 88, wherein at least one of the first facing or the second facing comprises a single-layer structure.

Exemplary claim 90. The building panel according to any one of Exemplary claims 80 to 88, wherein at least one of the first facing or the second facing comprises a multi-layer structure.

Exemplary claim 91. The building panel according to any one of Exemplary claims 80 to 90, wherein the first facing overlays an entirety of the first major surface of the core.

Exemplary claim 92. The building panel according to any one of Exemplary claims 80 to 91, wherein the second facing overlays an entirety of the second major surface of the core.

Exemplary claim 93. The building panel according to any one of Exemplary claims 80 to 92, wherein at least one of the first facing or the second facing has a thickness ranging from about 1 mil to about 40 mils.

Exemplary claim 94. The building panel according to any one of Exemplary claims 80 to 93, wherein the core further comprises a reinforcement member disposed between the first major surface and the second major surface.

Exemplary claim 95. The building panel according to Exemplary claim 94, wherein the reinforce member comprises at least one of a fiberglass mesh, felt mesh, metal wire mesh, or fabric mesh.

Exemplary claim 96. The building panel according to any one of Exemplary claims 94 to 95, wherein a length of the reinforcement member substantially corresponds to at least one of a length of the first major surface or a length of the second major surface.

Exemplary claim 97. The building panel according to any one of Exemplary claims 94 to 96, wherein a width of the reinforcement member substantially corresponds to at least one of a width of the first major surface or a width of the second major surface.

Exemplary claim 98. The building panel according to any one of Exemplary claims 80 to 97, wherein the thickness of the core ranges from about 2 mm to about 50 mm.

Exemplary claim 99. A building panel, comprising: a body comprising: a first major surface; a second major surface opposite the first major surface; a core between the first major surface and the second major surface; a tongue formed along a first edge portion of the body; and a groove formed along a second edge portion of the body opposite the first edge portion of the body; wherein: the core comprises a composite comprising MgO and MgSO₄; and a difference between a height of the groove and a height of the tongue ranges from about 0.1 mm to about 15 mm.

Exemplary claim 100. The building panel according to Exemplary claim 99, wherein the groove is configured to receive therein a tongue of another building panel and a portion of a mounting member.

Exemplary claim 101. The building panel according to any one of Exemplary claims 99 to 100, wherein at least one of the tongue or the groove is defined by the core.

Exemplary claim 102. The building panel according to any one of Exemplary claims 99 to 101, wherein the height of the tongue ranges from 1.3 mm to 25 mm.

Exemplary claim 103. The building panel according to any one of Exemplary claims 99 to 102, wherein the height of the groove ranges from 1.5 mm to 30 mm.

Exemplary claim 104. The building panel according to any one of Exemplary claims 99 to 103, wherein a ratio of a thickness of the body to the height of the tongue ranges from 38.5:1 to 1.2:1.

Exemplary claim 105. The building panel according to any one of Exemplary claims 99 to 104, wherein a ratio of a thickness of the body to the height of the groove ranges from 38:1 to 1.1:1.

Exemplary claim 106. The building panel according to any one of Exemplary claims 99 to 105, wherein the height of the groove is greater than the height of the tongue by about 5% to about 70% of the height of the tongue.

Exemplary claim 107. The building panel according to any one of Exemplary claims 99 to 106, wherein a difference between the height of the groove and the height of the tongue is about 0.5 mm.

Exemplary claim 108. The building panel according to any one of Exemplary claims 99 to 107, wherein: the body comprises a first overhang and a second overhang; the first overhang and the second overhang define at least in part the groove; the first overhang comprises an outer surface forming a portion of the first major surface of the body and an inner surface opposite the outer surface of the first overhang; the second overhang comprises an outer surface forming a portion of the second major surface of the body and an inner surface opposite the outer surface of the second overhang; the height of the groove is defined by a distance between the inner surface of the first overhang and the inner surface of the second overhang; the tongue comprises a first surface and a second surface opposite the first surface of the tongue; and the height of the tongue is defined by a distance between the first surface of the tongue and the second surface of the tongue.

Exemplary claim 109. The building panel according to Exemplary claim 108, wherein: the first surface of the tongue is substantially planar; the second surface of the tongue is substantially planar; the inner surface of the first overhang is substantially planar; and the inner surface of the second overhang is substantially planar.

Exemplary claim 110. The building panel according to any one of Exemplary claims 108 to 109, wherein the first surface of the tongue is offset from the first major surface of the body by a vertical distance that substantially corresponds to a vertical distance between the first major surface of the body and the inner surface of the first overhang.

Exemplary claim 111. The building panel according to any one of Exemplary claims 108 to 110, wherein the second surface of the tongue is offset from the second major surface of the body by a vertical distance that is greater than a vertical distance between the second major surface of the body and the inner surface of the second overhang.

Exemplary claim 112. The building panel according to any one of Exemplary claims 108 to 110, wherein the second surface of the tongue is offset from the second major surface of the body by a vertical distance that substantially corresponds to a vertical distance between the second major surface of the body and the inner surface of the second overhang.

Exemplary claim 113. The building panel according to any one of Exemplary claims 108 to 109, wherein the first surface of the tongue is offset from the first major surface of the body by a vertical distance that is greater than a vertical distance between the first major surface of the body and the inner surface of the first overhang.

Exemplary claim 114. The building panel according to any one of Exemplary claims 108 to 113, wherein the first overhang comprises a side surface between the outer surface and the inner surface of the first overhang.

Exemplary claim 115. The building panel according to Exemplary claim 114, wherein the side surface of the first overhang is sloped relative to the outer surface of the first overhang.

Exemplary claim 116. The building panel according to Exemplary claim 114 to 115, wherein the side surface of the first overhang is sloped relative to the outer surface of the first overhang at an angle ranging from about 20 degrees to 90 degrees.

Exemplary claim 117. The building panel according to Exemplary claim 114, wherein the side surface of the first overhang is substantially perpendicular to the outer surface of the first overhang.

Exemplary claim 118. The building panel according to Exemplary claim 114, wherein a corner defined by the side surface of the first overhang and the outer surface of the first overhang is beveled or chamfered such that a sloped edge is formed between the side surface of the first overhang and the outer surface of the first overhang.

Exemplary claim 119. The building panel according to Exemplary claim 118, wherein the sloped edge is sloped relative to the side surface of the first overhang at an angle ranging from about 0 degrees to about 70 degrees.

Exemplary claim 120. The building panel according to any one of Exemplary claims 114, wherein: the second overhang comprises a side surface extending between the outer surface and the inner surface of the second overhang; and the side surface of the first overhang and the side surface of the second overhang are substantially coplanar or aligned vertically.

Exemplary claim 121. The building panel according to any one of Exemplary claims 108 to 120, wherein the body further comprises: a first side surface extending between the first surface of the tongue and the first major surface of the body; and a second side surface extending between the second surface of the tongue and the second major surface of the body.

Exemplary claim 122. The building panel according to Exemplary claim 121, wherein the first side surface of the body is sloped relative to the first major surface of the body.

Exemplary claim 123. The building panel according to any one of Exemplary claims 121 to 122, wherein the first side surface of the body is sloped relative to the first major surface of the body at an angle ranging from about 20 degrees to 90 degrees.

Exemplary claim 124. The building panel according to Exemplary claim 121, wherein the first side surface of the body is substantially perpendicular to the first major surface of the body.

Exemplary claim 125. The building panel according to Exemplary claim 121, wherein a corner defined by the first side surface of the body and the first major surface of the body is beveled or chamfered such that a sloped edge is formed between the first side surface of the body and the first major surface of the body.

Exemplary claim 126. The building panel according to Exemplary claim 125, wherein the sloped edge is sloped relative to the first major surface of the body at an angle ranging from about 20 degrees to 90 degrees.

Exemplary claim 127. The building panel according to any one of Exemplary claims 121, wherein the first side surface of the body and the second side surface of the body are substantially coplanar or aligned vertically.

Exemplary claim 128. The building panel according to any one of Exemplary claims 121 to 127, wherein the tongue comprises a side surface defining a terminal end of the tongue.

Exemplary claim 129. The building panel according to Exemplary claim 128, wherein: a width of the first surface of the tongue extends between the first side surface of the body and the side surface of the tongue; and a width of the second surface of the tongue extending between the second side surface of the body and the side surface of the tongue.

Exemplary claim 130. The building panel according to Exemplary claim 129, wherein the width of the first surface of the tongue is different from the width of the second surface of the tongue.

Exemplary claim 131. The building panel according to any one of Exemplary claims 129 to 130, wherein the width of the first surface of the tongue is less than the width of the second surface of the tongue.

Exemplary claim 132. The building panel according to any one of Exemplary claims 129 to 131, wherein a difference between the width of the first surface of the tongue and the width of the second surface of the tongue ranges from about 1 mm to about 20 mm.

Exemplary claim 133. The building panel according to any one of Exemplary claims 129 to 132, wherein a width of the tongue is defined by the lesser of the width of the first surface of the tongue or the width of the second surface of the tongue.

Exemplary claim 134. The building panel according to Exemplary claim 133, wherein the width of the tongue ranges from about 3 mm to about 25 mm.

Exemplary claim 135. The building panel according to any one of Exemplary claims 133 to 134, wherein a ratio of the width of the tongue to the height of the tongue ranges from 0.05:1 to 20:1.

Exemplary claim 136. The building panel according to any one of Exemplary claims 133 to 135, wherein: a thickness of the body is defined by a distance between the first major surface and the second major surface of the body; and a ratio of the width of the tongue to the thickness of the body ranges from 0.06:1 to 10:1.

Exemplary claim 137. A building panel, comprising: a body, the body comprising: a first major surface; a second major surface opposite a first major surface; a slot formed in the first major surface and extending from the first major surface towards the second major surface; and a plurality of perforations formed in the second major surface and extending from the second major surface towards the first major surface; wherein at least one perforation of the plurality of perforations extends from the second major surface to a bottom end of the slot such that an air flow passageway is formed between the first major surface and the second major surface through the slot and the at least one perforation.

Exemplary claim 138. The building panel according to Exemplary claim 137, wherein a diameter of the at least one perforation is greater than a width of the slot.

Exemplary claim 139. The building panel according to any one of Exemplary claims 137 to 138, wherein a diameter of the at least one perforation ranges from about 50 mils to about 4 inches.

Exemplary claim 140. The building panel according to any one of Exemplary claims 137 to 139, wherein a diameter of the at least one perforation ranges from about 50 mils to about 2 inches.

Exemplary claim 141. The building panel according to any one of Exemplary claims 137 to 140, wherein a density of the plurality of perforations ranges from about 1 perforation per ft² to about 100 perforations per ft².

Exemplary claim 142. The building panel according to any one of Exemplary claims 137 to 141, wherein a depth of the slot is less than a thickness of the body.

Exemplary claim 143. The building panel according to Exemplary claim 142, wherein a ratio of the depth of the slot to the thickness of the body ranges from about 1:100 to about 1:2.

Exemplary claim 144. The building panel according to any one of Exemplary claims 142 to 143, wherein the depth of the slot ranges from 1 mm to 30 mm.

Exemplary claim 145. The building panel according to any one of Exemplary claims 137 to 144, wherein a depth of the at least one perforation is less than a thickness of the body.

Exemplary claim 146. The building panel according to Exemplary claim 145, wherein a ratio of the depth of the at least one perforation to the thickness of the body ranges from about 5% to about 100%.

Exemplary claim 147. The building panel according to any one of Exemplary claims 145 to 146, wherein the depth of the at least one perforation ranges from about 1 mm to about 50 mm.

Exemplary claim 148. The building panel according to any one of Exemplary claims 137 to 147, further comprising an acoustical layer over the second major surface of the body.

Exemplary claim 149. The building panel according to Exemplary claim 148, the acoustical layer comprises at least one of a fleece layer, a fiberglass scrim, a fabric, or a mesh.

Exemplary claim 150. The building panel according to any one of Exemplary claims 137 to 149, further comprising a slot formed in the second major surface and extending from the second major surface towards the first major surface.

Exemplary claim 151. The building panel according to Exemplary claim 150, wherein the slot formed in the second major surface is offset from the slot formed in the first major surface.

Exemplary claim 152. The building panel according to any one of Exemplary claims 137 to 151, wherein a depth of the slot formed in the second major surface is less than a thickness of the body.

Exemplary claim 153. The building panel according to any one of Exemplary claims 137 to 152, wherein the body comprises a tongue and a groove.

Exemplary claim 154. The building panel according to Exemplary claim 153, wherein a height of the groove is greater than a height of the tongue.

Exemplary claim 155. The building panel according to any one of Exemplary claims 137 to 154, wherein the body comprises a composite including MgO and MgSO₄.

Exemplary claim 156. The building panel according to Exemplary claim 155, wherein at least 65% of a volume of the body is occupied by the composite.

Exemplary claim 157. A building panel system, comprising: a first building panel comprising a core having a side surface and a tongue extending from the side surface; a second building panel comprising a core having an overhang and a groove defined at least in part by the overhang and configured to receive the tongue of the first building panel; wherein: at least one of the core of the first building panel or the core of the second building panel comprises MgO and MgSO₄; and the first building panel and the second building panel are configured such that when the tongue of the first building panel is received in the groove of the second building panel, a first gap is formed between the side surface of the first building panel and the overhang of the second building panel, and a second gap is formed between the tongue of the first building panel and the overhang of the second building panel.

Exemplary claim 158. The building panel system of claim 157, further comprising: a mounting member comprising a web and a mounting flange extending from the web; wherein the first building panel, the second building panel, and the mounting member are configured such that: at least a portion of the web of the mounting member is receivable in the first gap; at least a portion of the mounting flange is receivable in the second gap; and the tongue of the first building panel and the mounting flange of the mounting member are receivable in the groove of the second building pane in an overlapping configuration.

Exemplary claim 159. A building panel system, comprising: a first building panel comprising a core having a tongue; and a second building panel comprising a core having a groove configured to receive therein the tongue of the first building panel and at least portion of a mounting flange of a mounting member; wherein at least one of the core of the first building panel or the core of the second building panel comprises MgO and MgSO₄.

Exemplary claim 160. The building panel system of claim 159, wherein the groove of the second building panel is configured to receive therein the tongue of the first building panel and the mounting flange of the mounting member in an overlapping or substantially parallel manner.

Exemplary claim 161. A building panel system, comprising: a first building panel comprising a core having a tongue; a second building panel comprising a core having a groove; and a mounting member comprising a mounting flange; wherein: at least one of the core of the first building panel or the core of the second building panel comprises MgO and MgSO₄; and the first building panel, the second building panel, and the mounting member are configured such that the tongue of the first building panel and at least a portion of the mounting flange of the mounting member are receivable in an overlapping configuration in the groove of the second building pane.

Exemplary claim 162. A method of forming a building panel, the method comprising: forming a core of a body of a building panel, the core comprising: a first major surface; a second major surface opposite the first major surface; a thickness defined by a distance between the first major surface and the second major surface; and a volume defined at least in part by the first major surface and the second major surface; wherein: at least 95% of the volume of the core is occupied by a composite comprising MgO and MgSO₄; and the thickness of the core is greater than 85% of a thickness of the body.

Exemplary claim 163. The method according to Exemplary claim 162, wherein a density of the composite is substantially uniform within the at least 95% of the volume of the core occupied by the composite.

Exemplary claim 164. The method according to any one of Exemplary claims 162 to 163, wherein: the core further comprises a reinforcement member; and forming the core comprises: forming a mixture comprising MgO, MgSO₄, and water; flowing at least a portion of the mixture onto a material layer forming the reinforcement member, whereby the mixture penetrates the material layer and covers both sides of the material layer to form a web; and drying the web.

Exemplary claim 165. The method according to Exemplary claim 164, wherein forming the core further comprising: cutting the web into sheets; and curing the sheets.

Exemplary claim 166. The method according to any one of Exemplary claims 162 to 165, further comprising: providing a first facing to a first major surface of the core; and providing a second facing to a second major surface of the core.

Exemplary claim 167. The method according to any one of Exemplary claims 162 to 166, further comprising: forming a tongue along a first edge portion of the body; and forming a groove along a second edge portion of the body opposite the first edge portion of the body.

Exemplary claim 168. A method of forming a building panel, the method comprising: forming a core, wherein the core comprising a first major surface and a second major surface opposite the first major surface; providing a first facing to the first major surface of the core; and providing a second facing to the second major surface of the core; wherein: the core comprising a composite comprising MgO and MgSO4; the core, the first facing, and the second facing collectively form a body of the building panel; a thickness of the core is greater than 85% of a thickness of the body; and a density of the composite is substantially uniform across the entire thickness of the core.

Exemplary claim 169. The method according to Exemplary claim 168, wherein the composite is substantially free of MgCl₂.

Exemplary claim 170. A method of installing a building panel system, the building panel system comprising a first building panel comprising a core having an overhang and a groove defined at least in part by the overhang, a second building panel comprising a core having a side surface and a tongue extending from the side surface, and a mounting member comprising a web and a mounting flange extending from the web, the method comprising: positioning the mounting flange of the mounting member inside the groove of the first building panel such that the overhang of the first building panel rests upon the mounting flange of the mounting member; and positioning the tongue of the second building panel into the groove of the first building panel such that the mounting flange of the mounting member is disposed between the overhang of the first building panel and the tongue of the second building panel, and the web of the mounting member is disposed between a gap defined by the overhang of the first building panel and the side surface of the second building panel; wherein at least one of the core of the first building panel or the core of the second building panel comprises MgO and MgSO₄.

Exemplary claim 171. The method according to Exemplary claim 170, further comprising, prior to positioning the mounting flange of the mounting member inside the groove of the first building panel, positioning the mounting member on a support structure.

What is claimed is:

1. A building panel, comprising:
a body, the body comprising:
a core, the core comprising:
a first major surface;
a second major surface opposite the first major surface;
a thickness defined by a distance between the first major surface and the second major surface; and
a volume defined at least in part by the first major surface and the second major surface;
wherein:
at least 95% of the volume of the core is occupied by a composite comprising MgO and MgSO₄; and
the thickness of the core is greater than 85% of a thickness of the body.

2. The building panel according to claim 1, wherein:
the body comprises a first major surface, and a second major surface opposite the first major surface;
the thickness of the body is defined by a distance between the first major surface of the body and the second major surface of the body;
the first major surface of the body defines an exterior or exposed surface of the building panel; and
the second major surface of the body defines an exterior or exposed surface of the building panel.

3. The building panel according to any one of claims 1 to 2, wherein a density of the composite is substantially uniform within the at least 95% of the volume of the core occupied by the composite.

4. The building panel according to any one of claims 1 to 3, wherein:
an entirety of the first major surface of the core is substantially planar and/or continuous;
and an entirety of the second major surface of the core is substantially planar and/or continuous.

5. The building panel according to any one of claims 1 to 4, wherein a density of the core ranges from about 0.6 g/cm³ to about 1.8 g/cm³, 0.8 g/cm³ to about 1.6 g/cm³, from about 1.1 g/cm³ to about 1.4 g/cm³, or from about 1 g/cm³ to about 1.4g/cm³.

6. The building panel according to any one of claims 1 to 4, wherein a density of the core is less than 1.1 g/cm³ or less than 1 g/cm³.

7. The building panel according to any one of claims 1 to 4, wherein a density of the core ranges from about 0.6 g/cm³ to about 1 g/cm³ or from about 0.8 g/cm³ to about 1 g/cm³.

8. The building panel according to any one of claims 1 to 4, wherein a density of the composite ranges from about 0.6 g/cm³ to about 1.8 g/cm³, 0.8 g/cm³ to about 1.6 g/cm³, from about 1.1 g/cm³ to about 1.4 g/cm³, or from about 1 g/cm³ to about 1.4 g/cm³.

9. The building panel according to any one of claims 1 to 4, wherein a density of the composite is less than 1.1 g/cm³ or less than 1 g/cm³.

10. The building panel according to any one of claims 1 to 4, wherein a density of the composite ranges from about 0.6 g/cm³ to about 1 g/cm³ or from about 0.8 g/cm³ to about 1 g/cm³.

11. The building panel according to any one of claims 1 to 10, wherein the composite comprises, based on a weight of the composite:
50. wt. % to 87 wt. % of MgO; and
15. wt. % to 45 wt. % of MgSO₄.

12. The building panel according to any one of claims 1 to 11, wherein the composite comprises, based on the weight of the composite:
1 wt. % to 15 wt. % of perlite; and
1 wt. % to 20 wt. % of a cellulosic fiber.

13. The building panel according to any one of claims 1 to 12, wherein the composite comprises:
no greater than 1% of oxide other than MgO;
no greater than 1% of chloride ions; and
no greater than 1% of sodium ions.

14. The building panel according to any one of claims 1 to 13, wherein the core is substantially free of MgCl₂.

15. The building panel according to any one of claims 1 to 14, wherein the core further comprises a reinforcement member disposed between the first major surface of the core and the second major surface of the core.

16. The building panel according to claim 15, wherein the reinforce member comprises at least one of a fiberglass mesh, felt mesh, metal wire mesh, or fabric mesh.

17. The building panel according to any one of claims 15 to 16, wherein a thickness of the reinforcement member ranges from about 0.5 mil to about 50 mil.

18. The building panel according to any one of claims 15 to 17, wherein a thickness of the reinforcement member ranges from about 0.02% to about 64% of the thickness of the core.

19. The building panel according to any one of claims 15 to 18, wherein a length of the reinforcement member substantially corresponds to at least one of a length of the first major surface of the core or a length of the second major surface of the core.

20. The building panel according to any one of claims 15 to 19, wherein a width of the reinforcement member substantially corresponds to at least one of a width of the first major surface of the core or a width of the second major surface of the core.

21. The building panel according to any one of claims 1 to 20, wherein:
the core further comprises a side surface extending between the first major surface and the second major surface; and
the side surface is substantially planar.

22. The building panel according to any one of claims 1 to 20, wherein the body further comprises:
a first groove formed along a first edge portion of the body; and
a second groove formed along a second edge portion of the body opposite the first edge portion of the body.

23. The building panel according to any one of claims 1 to 20, wherein the body further comprises:
a tongue formed along a first edge portion of the body; and
a groove formed along a second edge portion of the body opposite the first edge portion of the body.

24. The building panel according to claim 23, wherein at least one of the tongue or the groove is defined by the core.

25. The building panel according to any one of claims 23 to 24, wherein a height of the groove is greater than a height of the tongue.

26. The building panel according to any one of claims 23 to 25, wherein the groove is configured to receive therein a tongue of another building panel and a portion of a mounting member.

27. The building panel according to claim 23, wherein:
the core comprises a first overhang and a second overhang;
the first overhang and the second overhang define at least in part the groove;
the first overhang comprises an outer surface forming a portion of a first major surface of the body and an inner surface opposite the outer surface of the first overhang;
the second overhang comprises an outer surface forming a portion of a second major surface of the body and an inner surface opposite the outer surface of the second overhang;
a height of the groove is defined by a distance between the inner surface of the first overhang and the inner surface of the second overhang;
the tongue comprises a first surface and a second surface opposite the first surface of the tongue; and
a height of the tongue is defined by a distance between the first surface of the tongue and the second surface of the tongue.

28. The building panel according to claim 27, wherein the height of the groove is greater than the height of the tongue.

29. The building panel according to any one of claims 27 to 28, wherein the height of the tongue ranges from 1.3 mm to 25 mm.

30. The building panel according to any one of claims 27to 29, wherein the height of the groove ranges from 1.5 mm to 30 mm.

31. The building panel according to any one of claims 27 to 30, wherein a ratio of the thickness of the core to the height of the tongue ranges from 38:1 to 1.2:1.

32. The building panel according to any one of claims 27 to 31, wherein a ratio of the thickness of the core to the height of the groove ranges from 38:1 to 1.1:1.

33. The building panel according to any one of claims 27 to 32, wherein the height of the groove is greater than the height of the tongue by about 2% to about 100% of the height of the tongue.

34. The building panel according to any one of claims 27 to 33, wherein a difference between the height of the groove and the height of the tongue ranges from about 0.1 mm to about 15 mm.

35. The building panel according to any one of claims 27 to 34, wherein a difference between 63 the height of the groove and the height of the tongue is about 0.5 mm.

36. The building panel according to any one of claims 27 to 35, wherein the first surface of the tongue is offset from the first major surface of the core by a vertical distance that substantially corresponds to a vertical distance between the first major surface of the core and the inner surface of the first overhang.

37. The building panel according to any one of claims 27 to 36, wherein the second surface of the tongue is offset from the second major surface of the core by a vertical distance that is greater than a vertical distance between the second major surface of the core and the inner surface of the second overhang.

38. The building panel according to any one of claims 27 to 36, wherein the second surface of the tongue is offset from the second major surface of the core by a vertical distance that substantially corresponds to a vertical distance between the second major surface of the core and the inner surface of the second overhang.

39. The building panel according to any one of claims 27 to 35, wherein the first surface of the tongue is offset from the first major surface of the core by a vertical distance that is greater than a vertical distance between the first major surface of the core and the inner surface of the first overhang.

40. The building panel according to any one of claims 27 to 39, wherein the first overhang comprises a side surface between the outer surface and the inner surface of the first overhang.

41. The building panel according to claim 40, wherein the side surface of the first overhang is sloped relative to the outer surface of the first overhang.

42. The building panel according to any one of claims 40 to 41, wherein the side surface of the first overhang is sloped relative to the outer surface of the first overhang at an angle ranging from about 20 degrees to 90 degrees.

43. The building panel according to claim 40, wherein the side surface of the first overhang is substantially perpendicular to the outer surface of the first overhang.

44. The building panel according to claim 40, wherein a corner defined by the side surface of the first overhang and the outer surface of the first overhang is beveled or chamfered such that a sloped edge is formed between the side surface of the first overhang and the outer surface of the first overhang.

45. The building panel according to claim 44, wherein the sloped edge is sloped relative to the side surface of the first overhang at an angle ranging from about 0 degree to about 70 degrees.

46. The building panel according to claim 40, wherein:
the second overhang comprises a side surface extending between the outer surface and the inner surface of the second overhang; and
the side surface of the first overhang and the side surface of the second overhang are substantially coplanar or aligned vertically.

47. The building panel according to any one of claims 27 to 46, wherein the core further comprises:
a first side surface extending between the first surface of the tongue and the first major surface of the core; and
a second side surface extending between the second surface of the tongue and the second major surface of the core.

48. The building panel according to claim 47, wherein the first side surface of the core is sloped relative to the first major surface of the core.

49. The building panel according to any one of claims 47 to 48, wherein the first side surface of the core is sloped relative to the first major surface of the core at an angle ranging from about 20 degrees to 90 degrees.

50. The building panel according to claim 47, wherein the first side surface of the core is substantially perpendicular to the first major surface of the core.

51. The building panel according to claim 47, wherein a corner defined by the first side surface of the core and the first major surface of the core is beveled or chamfered such that a sloped edge is formed between the first side surface of the core and the first major surface of the core.

52. The building panel according to claim 51, wherein the sloped edge is sloped relative to the first major surface of the core at an angle ranging from about 20 degrees to 90 degrees.

53. The building panel according to claim 47, wherein the first side surface of the core and the second side surface of the core are substantially coplanar or aligned vertically.

54. The building panel according to any one of claims 47 to 53, wherein the tongue comprises a side surface defining a terminal end of the tongue.

55. The building panel according to claim 55, wherein:
a width of the first surface of the tongue extends between the first side surface of the core and the side surface of the tongue; and
a width of the second surface of the tongue extending between the second side surface of the core and the side surface of the tongue.

56. The building panel according to claim 55, wherein the width of the first surface of the tongue is different from the width of the second surface of the tongue.

57. The building panel according to any one of claims 55 to 56, wherein the width of the first surface of the tongue is less than the width of the second surface of the tongue.

58. The building panel according to any one of claims 55 to 57, wherein a difference between the width of the first surface of the tongue and the width of the second surface of the tongue ranges from about 1 mm to about 20 mm.

59. The building panel according to any one of claims 55 to 58, wherein a width of the tongue is defined by the lesser of the width of the first surface of the tongue or the width of the second surface of the tongue.

60. The building panel according to claim 59, wherein a ratio of the width of the tongue to the height of the tongue ranges from 0.05:1 to 20:1.

61. The building panel according to any one of claims 59 to 60, wherein a ratio of the width of the tongue to the thickness of the core ranges from 20:1 to 1:1.

62. The building panel according to any one of claims 59 to 61, wherein the width of the tongue ranges from about 3 mm to about 25 mm.

63. The building panel according to any one of claims 27 to 62, wherein:
the first surface of the tongue is substantially planar;
the second surface of the tongue is substantially planar;
the inner surface of the first overhang is substantially planar; and
the inner surface of the second overhang is substantially planar.

64. The building panel according to any one of claims 1 to 63, wherein the body further comprises at least one of:
a first facing over at least a portion of the first major surface of the core; or a second facing over at least a portion of the second major surface of the core.

65. The building panel according to claim 64, wherein at least one of the first facing or the second facing comprises one or more layers of a melamine-based material, a low pressure laminate (LPL), a high pressure laminate (HPL), a scrim, a film, a coating, an ink layer, a veneer, or paper.

66. The building panel according to any one of claims 64 to 65, wherein at least one of the first facing or the second facing comprises a single-layer structure.

67. The building panel according to any one of claims 64 to 65, wherein at least one of the first facing or the second facing comprises a multi-layer structure.

68. The building panel according to any one of claims 64 to 67, wherein the first facing overlays an entirety of the first major surface of the core.

69. The building panel according to any one of claims 64 to 68, wherein the second facing overlays an entirety of the second major surface of the core.

70. The building panel according to any one of claims 64 to 69, wherein a thickness of the first facing ranging from about 1 mil to about 40 mils.

71. The building panel according to any one of claims 64 to 70, wherein a thickness of the second facing ranging from about 1 mil to about 40 mils.

72. The building panel according to any one of claims 64 to 71, wherein at least one of the first facing, the second facing, or the core comprises a plurality of perforations.

73. The building panel according to claim 72, wherein an average diameter of the plurality of perforations ranges from about 50 mils to 4 inches.

74. The building panel according to any one of claims 72 to 73, wherein an average diameter of the plurality of perforations ranges from about 50 mils to 2 inches.

75. The building panel according to any one of claims 72 to 74, wherein a density of the plurality of perforations ranges from about 1 perforation per ft² to about 100 perforations per ft².

76. The building panel according to any one of claims 1 to 75, wherein the thickness of the core ranges from about 2 mm to about 50 mm.

77. The building panel according to any one of claims 1 to 76, wherein:
a length of the body ranges from about 1 ft to 12 ft; and
a width of the body ranges from about 0.25 ft to 4.4 ft.

78. The building panel according to any one of claims 1 to 77, wherein a warpage of the body is less than 20 mm as measured by center gravity sag.

79. The building panel according to any one of claims 1 to 78, wherein the building panel comprises a ceiling panel.

80. A building panel, comprising:
a body, the body comprising:
a core, the core comprising:
a composite comprising MgO and MgSO₄;
a first major surface; and
a second major surface opposite the first major surface; and
a first facing over at least a portion of the first major surface of the core;
a second facing over at least a portion of the second major surface of the core; and
wherein:
a thickness of the core is defined by a distance between the first major surface and the second major surface;
a thickness of the body is defined by a distance between an exterior surface of the first facing and an exterior surface of the second facing;
the thickness of the core is greater than 85% of the thickness of the body; and
a density of the composite is substantially uniform across the entire thickness of the core.

81. The building panel according to claim 80, wherein a density of the core ranges from about 0.6 g/cm³ to about 1.8 g/cm³.

82. The building panel according to any one of claims 80 to 81, wherein a density of the core is less than 1g/cm³.

83. The building panel according to any one of claims 80 to 82, wherein the composite comprises:
50 wt. % to 87 wt. % of MgO; and
15 wt. % to 45 wt. % of MgSO₄.

84. The building panel according to any one of claims 80 to 83, wherein the composite comprises more than 55 wt. % of MgO.

85. The building panel according to any one of claims 80 to 84, wherein the composite further comprises:
1 wt. % to 15 wt. % of perlite; and
1 wt. % to 20 wt. % of a cellulosic fiber.

86. The building panel according to any one of claims 80 to 85, wherein the composite further comprises:
no greater than 1% of oxide other than MgO;
no greater than 1% of chloride ions; and
no greater than 1% of sodium ions.

87. The building panel according to any one of claims 80 to 86, wherein the composite is substantially free of MgCl₂.

88. The building panel according to any one of claims 80 to 87, wherein at least one of the first facing or the second facing comprises one or more layers of a melamine-based material, a low pressure laminate (LPL), a high pressure laminate (HPL), a scrim, a film, a coating, an ink layer, a veneer, or paper.

89. The building panel according to any one of claims 80 to 88, wherein at least one of the first facing or the second facing comprises a single-layer structure.

90. The building panel according to any one of claims 80 to 88, wherein at least one of the first facing or the second facing comprises a multi-layer structure.

91. The building panel according to any one of claims 80 to 90, wherein the first facing overlays an entirety of the first major surface of the core.

92. The building panel according to any one of claims 80 to 91, wherein the second facing overlays an entirety of the second major surface of the core.

93. The building panel according to any one of claims 80 to 92, wherein at least one of the first facing or the second facing has a thickness ranging from about 1 mil to about 40 mils.

94. The building panel according to any one of claims 80 to 93, wherein the core further comprises a reinforcement member disposed between the first major surface and the second major surface.

95. The building panel according to claim 94, wherein the reinforce member comprises at least one of a fiberglass mesh, felt mesh, metal wire mesh, or fabric mesh.

96. The building panel according to any one of claims 94 to 95, wherein a length of the reinforcement member substantially corresponds to at least one of a length of the first major surface or a length of the second major surface.

97. The building panel according to any one of claims 94 to 96, wherein a width of the reinforcement member substantially corresponds to at least one of a width of the first major surface or a width of the second major surface.

98. The building panel according to any one of claims 80 to 97, wherein the thickness of the core ranges from about 2 mm to about 50 mm.

99. A building panel, comprising:
a body comprising:
a first major surface;
a second major surface opposite the first major surface;
a core between the first major surface and the second major surface;
a tongue formed along a first edge portion of the body; and
a groove formed along a second edge portion of the body opposite the first edge portion of the body;
wherein:
the core comprises a composite comprising MgO and MgSO₄; and
a difference between a height of the groove and a height of the tongue ranges from about 0.1 mm to about 15 mm.

100. The building panel according to claim 99, wherein the groove is configured to receive therein a tongue of another building panel and a portion of a mounting member.

101. The building panel according to any one of claims 99 to 100, wherein at least one of the tongue or the groove is defined by the core.

102. The building panel according to any one of claims 99 to 101, wherein the height of the tongue ranges from 1.3 mm to 25 mm.

103. The building panel according to any one of claims 99 to 102, wherein the height of the groove ranges from 1.5 mm to 30 mm.

104. The building panel according to any one of claims 99 to 103, wherein a ratio of a thickness of the body to the height of the tongue ranges from 38.5:1 to 1.2:1.

105. The building panel according to any one of claims 99 to 104, wherein a ratio of a thickness of the body to the height of the groove ranges from 38:1 to 1.1:1.

106. The building panel according to any one of claims 99 to 105, wherein the height of the groove is greater than the height of the tongue by about 5% to about 70% of the height of the tongue.

107. The building panel according to any one of claims 99 to 106, wherein a difference between the height of the groove and the height of the tongue is about 0.5 mm.

108. The building panel according to any one of claims 99 to 107, wherein:
the body comprises a first overhang and a second overhang;
the first overhang and the second overhang define at least in part the groove;
the first overhang comprises an outer surface forming a portion of the first major surface of the body and an inner surface opposite the outer surface of the first overhang;
the second overhang comprises an outer surface forming a portion of the second major surface of the body and an inner surface opposite the outer surface of the second overhang;
the height of the groove is defined by a distance between the inner surface of the first overhang and the inner surface of the second overhang;
the tongue comprises a first surface and a second surface opposite the first surface of the tongue; and
the height of the tongue is defined by a distance between the first surface of the tongue and the second surface of the tongue.

109. The building panel according to claim 108, wherein:
the first surface of the tongue is substantially planar;
the second surface of the tongue is substantially planar;
the inner surface of the first overhang is substantially planar; and
the inner surface of the second overhang is substantially planar.

110. The building panel according to any one of claims 108 to 109, wherein the first surface of the tongue is offset from the first major surface of the body by a vertical distance that substantially corresponds to a vertical distance between the first major surface of the body and the inner surface of the first overhang.

111. The building panel according to any one of claims 108 to 110, wherein the second surface of the tongue is offset from the second major surface of the body by a vertical distance that is greater than a vertical distance between the second major surface of the body and the inner surface of the second overhang.

112. The building panel according to any one of claims 108 to 110, wherein the second surface of the tongue is offset from the second major surface of the body by a vertical distance that substantially corresponds to a vertical distance between the second major surface of the body and the inner surface of the second overhang.

113. The building panel according to any one of claims 108 to 109, wherein the first surface of the tongue is offset from the first major surface of the body by a vertical distance that is greater than a vertical distance between the first major surface of the body and the inner surface of the first overhang.

114. The building panel according to any one of claims 108 to 113, wherein the first overhang comprises a side surface between the outer surface and the inner surface of the first overhang.

115. The building panel according to claim 114, wherein the side surface of the first overhang is sloped relative to the outer surface of the first overhang.

116. The building panel according to claim 114 to 115, wherein the side surface of the first overhang is sloped relative to the outer surface of the first overhang at an angle ranging from about 20 degrees to 90 degrees.

117. The building panel according to claim 114, wherein the side surface of the first overhang is substantially perpendicular to the outer surface of the first overhang.

118. The building panel according to claim 114, wherein a corner defined by the side surface of the first overhang and the outer surface of the first overhang is beveled or chamfered such that a sloped edge is formed between the side surface of the first overhang and the outer surface of the first overhang.

119. The building panel according to claim 118, wherein the sloped edge is sloped relative to the side surface of the first overhang at an angle ranging from about 0 degrees to about 70 degrees.

120. The building panel according to any one of claims 114, wherein:
the second overhang comprises a side surface extending between the outer surface and the inner surface of the second overhang; and
the side surface of the first overhang and the side surface of the second overhang are substantially coplanar or aligned vertically.

121. The building panel according to any one of claims 108 to 120, wherein the body further comprises:
a first side surface extending between the first surface of the tongue and the first major surface of the body; and
a second side surface extending between the second surface of the tongue and the second major surface of the body.

122. The building panel according to claim 121, wherein the first side surface of the body is sloped relative to the first major surface of the body.

123. The building panel according to any one of claims 121 to 122, wherein the first side surface of the body is sloped relative to the first major surface of the body at an angle ranging from about 20 degrees to 90 degrees.

124. The building panel according to claim 121, wherein the first side surface of the body is substantially perpendicular to the first major surface of the body.

125. The building panel according to claim 121, wherein a corner defined by the first side surface of the body and the first major surface of the body is beveled or chamfered such that a sloped edge is formed between the first side surface of the body and the first major surface of the body.

126. The building panel according to claim 125, wherein the sloped edge is sloped relative to the first major surface of the body at an angle ranging from about 20 degrees to 90 degrees.

127. The building panel according to any one of claims 121, wherein the first side surface of the body and the second side surface of the body are substantially coplanar or aligned vertically.

128. The building panel according to any one of claims 121 to 127, wherein the tongue comprises a side surface defining a terminal end of the tongue.

129. The building panel according to claim 128, wherein:
a width of the first surface of the tongue extends between the first side surface of the body and the side surface of the tongue; and
a width of the second surface of the tongue extending between the second side surface of the body and the side surface of the tongue.

130. The building panel according to claim 129, wherein the width of the first surface of the tongue is different from the width of the second surface of the tongue.

131. The building panel according to any one of claims 129 to 130, wherein the width of the first surface of the tongue is less than the width of the second surface of the tongue.

132. The building panel according to any one of claims 129 to 131, wherein a difference between the width of the first surface of the tongue and the width of the second surface of the tongue ranges from about 1 mm to about 20 mm.

133. The building panel according to any one of claims 129 to 132, wherein a width of the tongue is defined by the lesser of the width of the first surface of the tongue or the width of the second surface of the tongue.

134. The building panel according to claim 133, wherein the width of the tongue ranges from about 3 mm to about 25 mm.

135. The building panel according to any one of claims 133 to 134, wherein a ratio of the width of the tongue to the height of the tongue ranges from 0.05:1 to 20:1.

136. The building panel according to any one of claims 133 to 135, wherein:
a thickness of the body is defined by a distance between the first major surface and the second major surface of the body; and
a ratio of the width of the tongue to the thickness of the body ranges from 0.06:1 to 10:1.

137. A building panel, comprising:
a body, the body comprising:
a first major surface;
a second major surface opposite a first major surface;
a slot formed in the first major surface and extending from the first major surface towards the second major surface; and
a plurality of perforations formed in the second major surface and extending from the second major surface towards the first major surface;
wherein at least one perforation of the plurality of perforations extends from the second major surface to a bottom end of the slot such that an air flow passageway is formed between the first major surface and the second major surface through the slot and the at least one perforation.

138. The building panel according to claim 137, wherein a diameter of the at least one perforation is greater than a width of the slot.

139. The building panel according to any one of claims 137 to 138, wherein a diameter of the at least one perforation ranges from about 50 mils to about 4 inches.

140. The building panel according to any one of claims 137 to 139, wherein a diameter of the at least one perforation ranges from about 50 mils to about 2 inches.

141. The building panel according to any one of claims 137 to 140, wherein a density of the plurality of perforations ranges from about 1 perforation per ft² to about 100 perforations per ft².

142. The building panel according to any one of claims 137 to 141, wherein a depth of the slot is less than a thickness of the body.

143. The building panel according to claim 142, wherein a ratio of the depth of the slot to the thickness of the body ranges from about 1:100 to about 1:2.

144. The building panel according to any one of claims 142 to 143, wherein the depth of the slot ranges from 1 mm to 30 mm.

145. The building panel according to any one of claims 137 to 144, wherein a depth of the at least one perforation is less than a thickness of the body.

146. The building panel according to claim 145, wherein a ratio of the depth of the at least one perforation to the thickness of the body ranges from about 5% to about 100%.

147. The building panel according to any one of claims 145 to 146, wherein the depth of the at least one perforation ranges from about 1 mm to about 50 mm.

148. The building panel according to any one of claims 137 to 147, further comprising an acoustical layer over the second major surface of the body.

149. The building panel according to claim 148, the acoustical layer comprises at least one of a fleece layer, a fiberglass scrim, a fabric, or a mesh.

150. The building panel according to any one of claims 137 to 149, further comprising a slot formed in the second major surface and extending from the second major surface towards the first major surface.

151. The building panel according to claim 150, wherein the slot formed in the second major surface is offset from the slot formed in the first major surface.

152. The building panel according to any one of claims 137 to 151, wherein a depth of the slot formed in the second major surface is less than a thickness of the body.

153. The building panel according to any one of claims 137 to 152, wherein the body comprises a tongue and a groove.

154. The building panel according to claim 153, wherein a height of the groove is greater than a height of the tongue.

155. The building panel according to any one of claims 137 to 154, wherein the body comprises a composite including MgO and MgSO₄.

156. The building panel according to claim 155, wherein at least 65% of a volume of the body is occupied by the composite.

157. A building panel system, comprising:
a first building panel comprising a core having a side surface and a tongue extending from the side surface;
a second building panel comprising a core having an overhang and a groove defined at least in part by the overhang and configured to receive the tongue of the first building panel;
wherein:
at least one of the core of the first building panel or the core of the second building panel comprises MgO and MgSO₄; and
the first building panel and the second building panel are configured such that when the tongue of the first building panel is received in the groove of the second building panel, a first gap is formed between the side surface of the first building panel and the overhang of the second building panel, and a second gap is formed between the tongue of the first building panel and the overhang of the second building panel.

158. The building panel system of claim 157, further comprising:
a mounting member comprising a web and a mounting flange extending from the web;
wherein the first building panel, the second building panel, and the mounting member are configured such that:
at least a portion of the web of the mounting member is receivable in the first gap;
at least a portion of the mounting flange is receivable in the second gap; and
the tongue of the first building panel and the mounting flange of the mounting member are receivable in the groove of the second building pane in an overlapping configuration.

159. A building panel system, comprising:
a first building panel comprising a core having a tongue; and
a second building panel comprising a core having a groove configured to receive therein the tongue of the first building panel and at least portion of a mounting flange of a mounting member;
wherein at least one of the core of the first building panel or the core of the second building panel comprises MgO and MgSO₄.

160. The building panel system of claim 159, wherein the groove of the second building panel is configured to receive therein the tongue of the first building panel and the mounting flange of the mounting member in an overlapping or substantially parallel manner.

161. A building panel system, comprising:
a first building panel comprising a core having a tongue;
a second building panel comprising a core having a groove; and
a mounting member comprising a mounting flange;
wherein:
at least one of the core of the first building panel or the core of the second building panel comprises MgO and MgSO₄; and
the first building panel, the second building panel, and the mounting member are configured such that the tongue of the first building panel and at least a portion of the mounting flange of the mounting member are receivable in an overlapping configuration in the groove of the second building pane.

162. A method of forming a building panel, the method comprising:
forming a core of a body of a building panel, the core comprising:
a first major surface;
a second major surface opposite the first major surface;
a thickness defined by a distance between the first major surface and the second major surface; and
a volume defined at least in part by the first major surface and the second major surface;
wherein:
at least 95% of the volume of the core is occupied by a composite comprising MgO and MgSO₄; and
the thickness of the core is greater than 85% of a thickness of the body.

163. The method according to claim 162, wherein a density of the composite is substantially uniform within the at least 95% of the volume of the core occupied by the composite.

164. The method according to any one of claims 162 to 163, wherein:
the core further comprises a reinforcement member; and
forming the core comprises:
forming a mixture comprising MgO, MgSO₄, and water;
flowing at least a portion of the mixture onto a material layer forming the reinforcement member, whereby the mixture penetrates the material layer and covers both sides of the material layer to form a web; and
drying the web.

165. The method according to claim 164, wherein forming the core further comprising:
cutting the web into sheets; and
curing the sheets.

166. The method according to any one of claims 162 to 165, further comprising:
providing a first facing to a first major surface of the core; and
providing a second facing to a second major surface of the core.

167. The method according to any one of claims 162 to 166, further comprising:
forming a tongue along a first edge portion of the body; and
forming a groove along a second edge portion of the body opposite the first edge portion of the body.

168. A method of forming a building panel, the method comprising:
forming a core, wherein the core comprising a first major surface and a second major surface opposite the first major surface;
providing a first facing to the first major surface of the core; and
providing a second facing to the second major surface of the core;
wherein:
the core comprising a composite comprising MgO and MgSO₄;
the core, the first facing, and the second facing collectively form a body of the building panel;
a thickness of the core is greater than 85% of a thickness of the body; and
a density of the composite is substantially uniform across the entire thickness of the core.

169. The method according to claim 168, wherein the composite is substantially free of MgCl₂.

170. A method of installing a building panel system, the building panel system comprising a first building panel comprising a core having an overhang and a groove defined at least in part by the overhang, a second building panel comprising a core having a side surface and a tongue extending from the side surface, and a mounting member comprising a web and a mounting flange extending from the web, the method comprising:
positioning the mounting flange of the mounting member inside the groove of the first building panel such that the overhang of the first building panel rests upon the mounting flange of the mounting member; and
positioning the tongue of the second building panel into the groove of the first building panel such that the mounting flange of the mounting member is disposed between the overhang of the first building panel and the tongue of the second building panel, and the web of the mounting member is disposed between a gap defined by the overhang of the first building panel and the side surface of the second building panel;
wherein at least one of the core of the first building panel or the core of the second building panel comprises MgO and MgSO₄.

171. The method according to claim 170, further comprising, prior to positioning the mounting flange of the mounting member inside the groove of the first building panel, positioning the mounting member on a support structure.
